(19) United States
(12) Patent Application Publication
(10) Pub. No.: US 2014/0063373 A1
(43) Pub. Date: Mar. 6, 2014

(54) TOUCH PANEL

(71) Applicants: Wintek Corporation, Taichung City (TW); Wintek (China) Technology Ltd., Dongguan City (CN)

(72) Inventors: Ming-Kung Wu, Taichung City (TW); Yi-Chun Lin, Changhua County (TW); Hui-Jou Chang, Taichung City (TW); Yu-Ting Lin, New Taipei City (TW); Shin-Chieh Huang, Taichung City (TW)

(73) Assignees: Wintek Corporation, Taichung City (TW); Wintek (China) Technology Ltd., Dongguan City (CN)

(21) Appl. No.: 14/017,254

(22) Filed: Sep. 3, 2013

(30) Foreign Application Priority Data
Sep. 3, 2012 (TW) 101132045

(51) Int. Cl. G02F 1/1333

(52) U.S. Cl. CPC G02F 1/13338
USPC 349/12

(57) ABSTRACT

A touch panel includes a substrate, a first conductive pattern, a first photoresist layer, a second conductive pattern, and a second photoresist layer. The first conductive pattern is disposed on the substrate, and the first conductive pattern includes a plurality of first axis electrodes. The first photoresist layer is disposed between the substrate and the first conductive pattern. The first photoresist layer completely covers the first conductive layer along a direction perpendicular to the substrate. The second conductive pattern is disposed on the substrate, and the second conductive pattern includes a plurality of second axis electrodes. The second axis electrodes are electrically isolated from the first axis electrodes. The second photoresist layer is disposed between the substrate and the second conductive pattern. The second photoresist layer completely covers the second conductive layer along the direction perpendicular to the substrate.

### BACKGROUND OF THE INVENTION

1. Field of the Invention

The present invention relates to a touch panel, and more particularly, to a touch panel with conductive patterns formed from a photosensitive conductive film on a substrate, wherein the photosensitive conductive film is made of a conductive layer and a photoresist layer stacked to each other.

2. Description of the Prior Art

In the conventional touch panel technologies, the fabrication process of a transparent electrode, which enables touch sensing capabilities, depends on the design requirements. For example, the transparent electrode may be formed on a side of a substrate or on both sides of a substrate before combining the substrate with a cover lens (or a cover glass). The transparent electrode may also be directly formed on the cover lens. However, generally speaking, the transparent electrodes are formed by carrying out photo-etching processes or screen printing processes on the transparent conductive layer. Additionally a film deposition process at higher temperature has to be performed to form the transparent conductive layer on the substrate. Therefore, no matter where the transparent electrodes are disposed, some issues, such as complicate processes and low yield, remain in the fabrication process.

Moreover, in the above-mentioned adhering process of the covered glass to the substrate, apart from the difficulties to stick hard substrates together by using optical adhesives, the stacked thickness is also a problem for compact products. When the transparent electrodes in different axes are disposed on the same side of the substrate, an insulation layer generally has to be used to electrically isolate the transparent electrodes in different axes. However, forming the insulation layer not only complicates the overall process but also affects the overall yield. For example, process variations of the insulation layer may cause poor contact or affect the appearance quality of the final product.

### SUMMARY OF THE INVENTION

One of the objectives of the present invention is to provide a touch panel. In the present invention, a photosensitive conductive film including a conductive layer and a photoresist layer stacked to each other is used to directly form conductive patterns on a substrate through exposure and developing processes, and the fabrication process of the touch panel is simplified. This way, the size of the touch panel is miniaturized and the overall yield rises. In addition, since the photosensitive conductive film includes a conductive layer, the conventional film deposition process at high temperature will not be necessary to form the transparent conductive layer on the substrate. Therefore, a low temperature process is realized in the method for fabricating the touch panel of the present invention. In other words, the choice range of the substrate becomes wider and the fabrication methods are further simplified.

To achieve the purposes described above, an embodiment of the disclosure provides a touch panel. The touch panel includes a substrate, a first conductive pattern, a first photoresist layer, a second conductive pattern and a second photoresist layer. The substrate has an upper surface and a lower surface opposite to the upper surface. The first conductive pattern is disposed on the substrate. The first conductive pattern includes a plurality of first axis electrodes. The first photoresist layer is disposed between the substrate and the first conductive pattern. The first photoresist layer completely covers the first conductive pattern along a direction perpendicular to the substrate. The second conductive pattern is disposed on the substrate. The second conductive pattern includes a plurality of second axis electrodes. The second axis electrodes are electrically isolated from the first axis electrodes. The second photoresist layer is disposed between the substrate and the second conductive pattern. The first conductive pattern, the first photoresist layer, the second conductive pattern, and the second photoresist layer are disposed on a side of the upper surface of the substrate.

Another embodiment of the disclosure provides a touch panel. The touch panel includes a substrate, a first conductive pattern, a first photoresist layer, a second conductive pattern and a second photoresist layer. The substrate has an upper surface and a lower surface opposite to the upper surface. The first conductive pattern is disposed on a side of the upper surface of the substrate. The first conductive pattern includes a plurality of first axis electrodes. The first photoresist layer is disposed between the substrate and the first conductive pattern. The first photoresist layer completely covers the first conductive pattern along a direction perpendicular to the substrate. The second conductive pattern is disposed on a side of the lower surface of the substrate. The second conductive pattern includes a plurality of second axis electrodes. The second axis electrodes are electrically isolated from the first axis electrodes. The second photoresist layer is disposed between the substrate and the second conductive pattern. The second photoresist layer completely covers the second conductive pattern along the direction perpendicular to the substrate.

Another embodiment of the disclosure provides a touch panel. The touch panel includes a substrate, a first conductive pattern, a first photoresist layer, a second conductive pattern and a second photoresist layer. The substrate has an upper surface and a lower surface opposite to the upper surface. The first conductive pattern is disposed on the substrate. The first conductive pattern includes a plurality of bridge conductors. The first photoresist layer is disposed between the substrate and the first conductive pattern. The first photoresist layer completely covers the first conductive pattern along a direction perpendicular to the substrate. The second conductive pattern is disposed on the substrate. The second conductive pattern includes a plurality of second axis electrodes and a plurality of first electrodes. The bridge conductors are electrically isolated from the second axis electrodes. Each of the bridge conductors is electrically connected to at least one of the first electrodes. The second photoresist layer is disposed between the substrate and the second conductive pattern. The second photoresist layer completely covers the second conductive pattern along a direction perpendicular to the substrate. The first conductive pattern, the first photoresist layer, the second conductive pattern, and the second photoresist layer are disposed on a side of the upper surface of the substrate.

Another embodiment of the disclosure provides a touch panel. The touch panel includes a substrate, a first conductive pattern and a first photoresist layer. The first conductive pattern is disposed on the substrate. The first conductive pattern includes a plurality of touch electrodes. The first photoresist layer is disposed between the substrate and the first conductive pattern. The first photoresist layer completely covers the first conductive pattern along a direction perpendicular to the substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a photosensitive conductive film according to an embodiment of the present invention.

FIG. 2 is a schematic diagram illustrating a photosensitive conductive film according to another embodiment of the present invention.

FIGS. 3-9 are schematic diagrams illustrating a method for fabricating a touch panel according to a first embodiment of the present invention.

FIGS. 10-14 are schematic diagrams illustrating a method for fabricating a touch panel according to a second embodiment of the present invention.

FIG. 15 is a schematic diagram illustrating a method for fabricating a touch panel according to a third embodiment of the present invention.

FIG. 16 is a schematic diagram illustrating a method for fabricating a touch panel according to a fourth embodiment of the present invention.

FIG. 17 is a schematic diagram illustrating a method for fabricating a touch panel according to a fifth embodiment of the present invention.

FIGS. 18-21 are schematic diagrams illustrating a method for fabricating a touch panel according to a sixth embodiment of the present invention.

FIG. 22 and FIG. 23 are schematic diagrams illustrating a method for fabricating a touch panel according to a seventh embodiment of the present invention.

FIG. 24 is a schematic diagram illustrating a touch panel according to an eighth embodiment of the present invention.

FIG. 25 is a cross-sectional view diagram taken along a cross-sectional line F-F′ in FIG. 24.

FIG. 26 is a schematic diagram illustrating a touch panel according to a ninth embodiment of the present invention.

FIG. 27 is a schematic diagram illustrating a decoration frame of a touch panel according to an embodiment of the present invention.

FIG. 28 is a schematic diagram illustrating a decoration frame of a touch panel according to another embodiment of the present invention.

FIG. 29 is a schematic diagram illustrating a touch panel according to a tenth embodiment of the present invention.

FIG. 30 is a schematic diagram illustrating a touch panel according to an eleventh embodiment of the present invention.

FIG. 31 is a schematic diagram illustrating a touch panel according to a twelfth embodiment of the present invention.

FIG. 32 is a schematic diagram illustrating a touch panel according to a thirteenth embodiment of the present invention.

FIG. 33 is a cross-sectional view diagram taken along a cross-sectional line G-G′ in FIG. 32.

FIG. 34 is a schematic diagram illustrating a touch panel according to a fourteenth embodiment of the present invention.

FIG. 35 is a schematic diagram illustrating a touch panel according to a fifteenth embodiment of the present invention.

FIG. 36 is a schematic diagram illustrating a touch panel according to a sixteenth embodiment of the present invention.

FIG. 37 is a cross-sectional view diagram taken along a cross-sectional line H-H′ in FIG. 36.

FIG. 38 is a schematic diagram illustrating a touch panel according to a seventeenth embodiment of the present invention.

FIG. 39 is a schematic diagram illustrating a touch panel according to an eighteenth embodiment of the present invention.

FIG. 40 is a schematic diagram illustrating a touch panel according to a nineteenth embodiment of the present invention.

FIG. 41 is a cross-sectional view diagram taken along a cross-sectional line I-I′ in FIG. 40.

### DETAILED DESCRIPTION

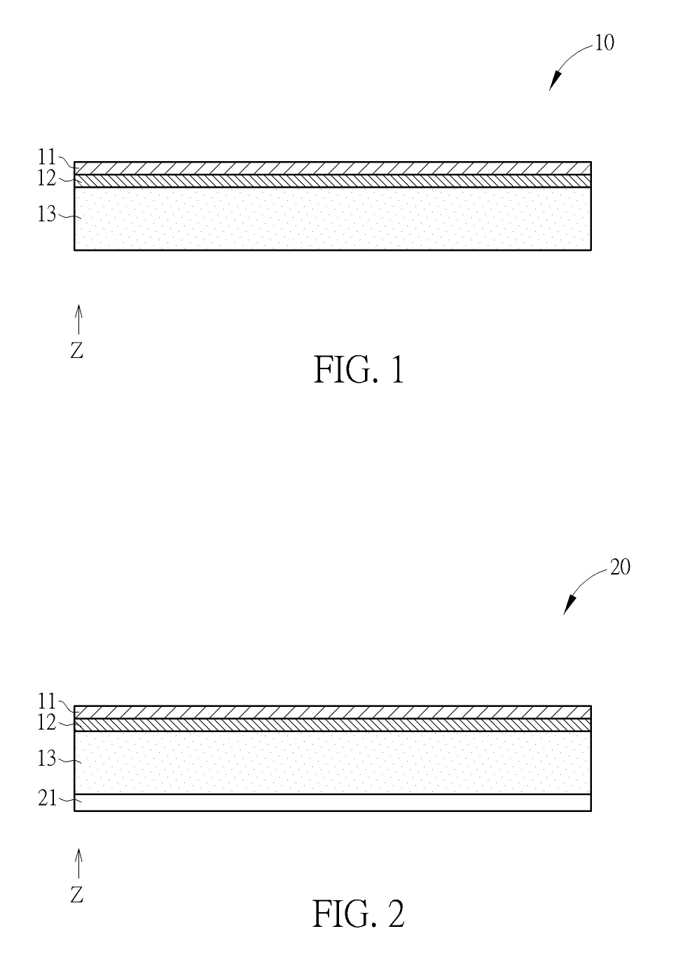

Please refer to FIG. 1 and FIG. 2. FIG. 1 is a schematic diagram illustrating a photosensitive conductive film according to an embodiment of the present invention. FIG. 2 is a schematic diagram illustrating a photosensitive conductive film according to another embodiment of the present invention. For brevity purposes, please note that the figures are only for illustration and the figures may not be to scale. The scale may be further modified according to different design considerations. As shown in FIG. 1, an embodiment of the present invention provides a photosensitive conductive film 10 configured to form a conductive pattern. The photosensitive conductive film 10 includes a photoresist layer 13, a conductive layer 12, and a release film 11. The conductive layer 12 is disposed on the photoresist layer 13. The release film 11 is disposed on the conductive layer 12 to protect the conductive layer 12. In other words, the conductive layer 12 is disposed between the release film 11 and the photoresist layer 13. The photosensitive conductive film 10 is formed by stacking the photosensitive photoresist layer 13, the conductive layer 12 and the release film 11 in that order along a direction Z.

In this embodiment, the photoresist layer 13 is preferably a dry photoresist layer 13, and the photoresist layer 13 is preferably a negative photoresist, but not limited thereto. Moreover, the photoresist layer 13 preferably includes an adhesives polymer (binder polymer), a photopolymerizable compound, such as a photo-polymerizable compound with ethylenically unsaturated bond, and a photopolymerization initiator or other suitable materials with adhesive and photosensitivity. The conductive layer 12 preferably includes transparent conductive materials, for example, indium tin oxide (ITO), indium zinc oxide (IZO), aluminum zinc oxide (AZO), or other appropriate transparent or opaque conductive materials, for example, silver (Ag), aluminum (Al), copper (Cu), magnesium (Mg), molybdenum (Mo), composite layers thereof, alloy thereof, conductive particles, carbon nanotubes and nano silver yarn, but not limited thereto. The surface impedance of the conductive layer 12 is preferably less than 1000Ω/□ (ohm/square) to meet the necessary conductive performance. The release film 11 preferably includes polyethylene terephthalate (PET), polyethersulfone (PES), polyimide (PI), polycarbonate (PC), polyethylene naphthalate (PEN), polymethyl methacrylate (PMMA) or other appropriate release film materials. In this embodiment, the haze of the conductive layer 12 and the haze of the photoresist layer 13 are preferably in a range between 0% and 3% to meet better optical performances, but not limited thereto. The light transmittance of the conductive layer 12 and the light transmittance of the photoresist layer 13 are preferably in a range between 80% and 100% to meet better optical performances, but not limited thereto. Because the photosensitive conductive film 10 in this embodiment is photosensitive and conductive, the conductive pattern may be formed directly on a target by exposure processes and development processes. Since the fabrication methods will be illustrated in the following paragraphs, they are not detailed here.

As shown in FIG. 2, a photosensitive conductive film 20 in another embodiment of the present invention may further include a support material layer 21, disposed on a side of the photoresist layer 13 away from the conductive layer 12. In other words, the photoresist layer 13 is disposed between the support material layer 21 and the conductive layer 12. The photosensitive conductive film 20 is formed by stacking the support material layer 21, the photoresist layer 13, the conductive layer 12, and the release film 11 in that order along a direction Z. In other words, the photoresist layer 13, the conductive layer 12 and the release film 11 may be formed on the support material layer 21 first. Then, the support material layer 21 is removed. The combination of the photoresist layer 13, the conductive layer 12 and the release film 11 adheres to the surface of the target by the exposed photoresist layer 13. The patterning process of the photoresist layer 13 and the conductive layer 12, such as exposure processes and development processes, may be carried out before or after the support material layer 21 is removed according to different design considerations, but not limited thereto. The support material layer 21 preferably includes hard support materials, such as glass and ceramic, flexible support materials, such as plastic, or other appropriate support materials.

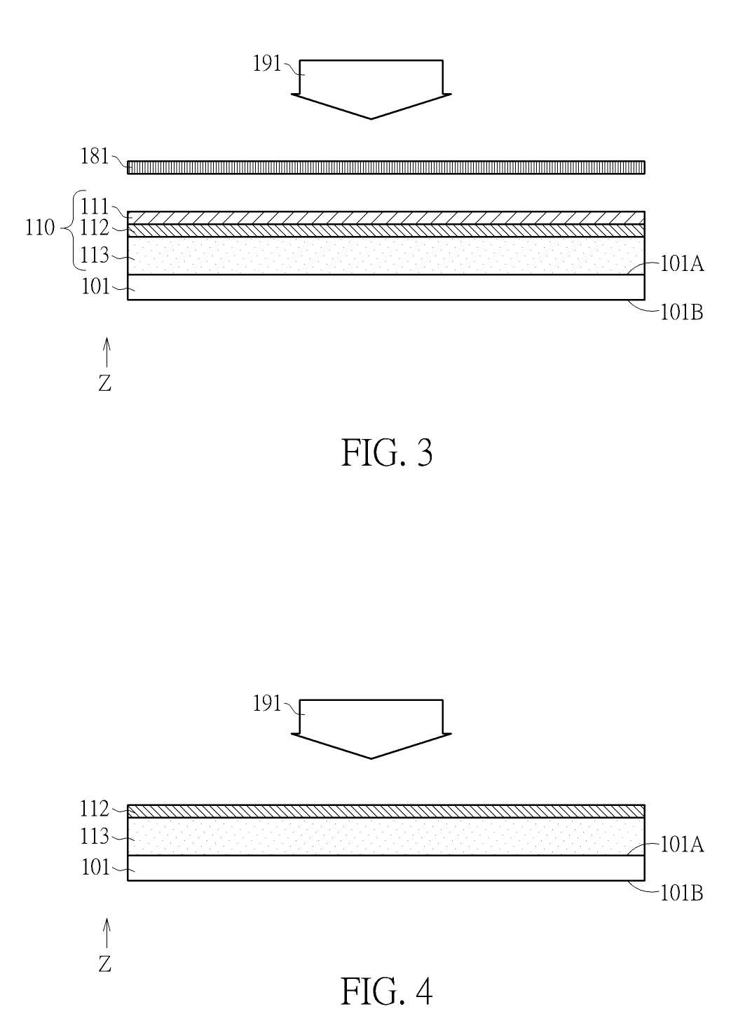

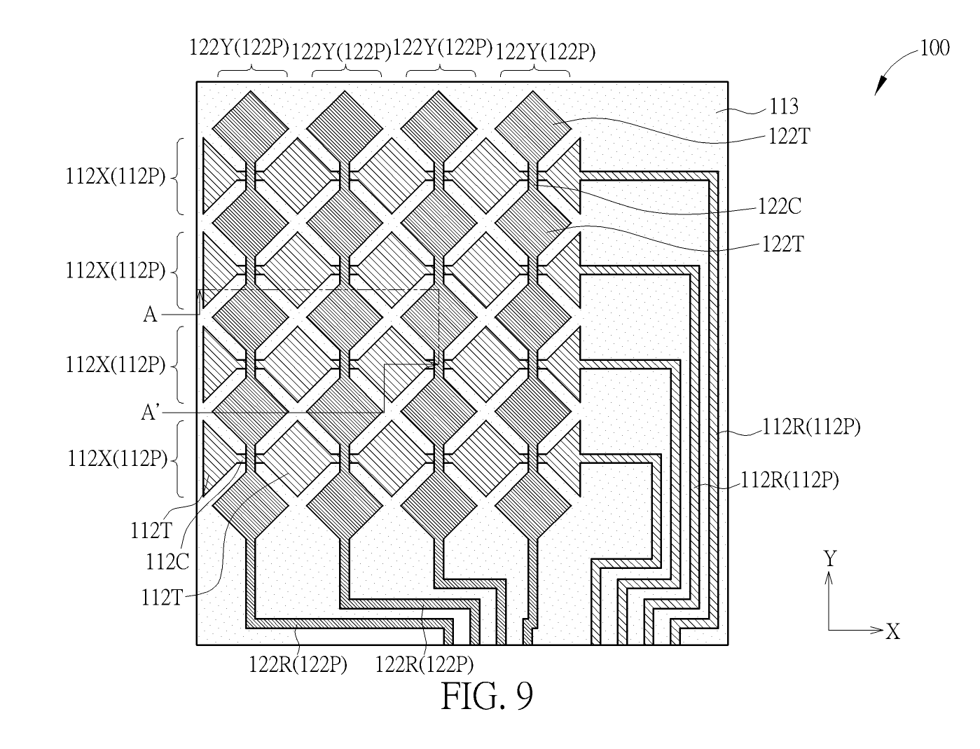

Please refer to FIGS. 3-9. FIGS. 3-9 are schematic diagrams illustrating a method for fabricating a touch panel according to a first embodiment of the present invention. FIGS. 3-8 are lateral-view schematic diagrams and FIG. 9 is a top-view schematic diagram. FIG. 8 may be regarded as a cross-sectional view diagram taken along a cross-sectional line A-A′ in FIG. 9. The method of fabricating the touch panel provided in this embodiment includes the following steps. As shown in FIG. 3, a substrate 101 is provided. The substrate 101 has an upper surface 101A and a lower surface 101B. A first photosensitive conductive film 110 is formed on the substrate 101. The first photosensitive conductive film 110 includes a first photoresist layer 113, a first conductive layer 112, and a first release film 111. The first conductive layer 112 is disposed on the first photoresist layer 113. The first release film 111 is disposed on the first conductive layer 112. In other words, the first conductive layer 112 is disposed between the first release film 111 and the first photoresist layer 113. The first photoresist layer 113 is disposed between the substrate 101 and the first conductive layer 112. In other words, the first photoresist layer 113, the first conductive layer 112 and the first release film 111 are stacked in that order upward on the substrate 101 along the direction Z perpendicular to the substrate 101. The arrangement and the material property of each layer of the first photosensitive conductive film 110 in this embodiment are similar to those of the photosensitive conductive film 10 in the embodiment detailed above and will not be redundantly described. It is worth noting that the first photosensitive conductive film 110 in this embodiment is preferably formed on the substrate 101 through a roll to roll process, a vacuum adhering process or other appropriate low temperature processes, but not limited thereto.

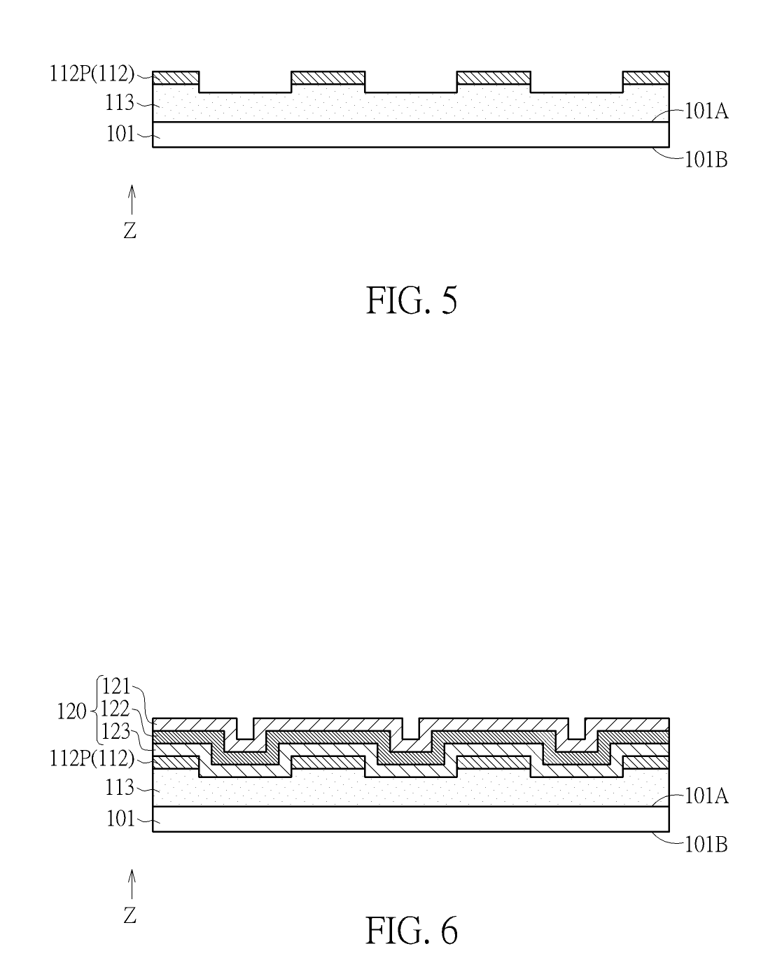

A first exposure process is then carried out. The first exposure process in this embodiment preferably includes a first local exposure process and a first full exposure process. As shown in FIG. 3, the first local exposure process is carried out on the first photosensitive conductive film 110 with a first mask 181 and a light source 191. Then, as shown in FIG. 4, after removing the first release film 111, the first full exposure process is carried out. In other words, in this embodiment, after the first local exposure process, the first release film 111 is removed to perform the first full exposure process. However, the present invention is not limited to this and the timing for removing the first release film 111 may be further modified according to other considerations. As shown in FIG. 5, a first development process is performed to remove a portion of the first photoresist layer 113 and a portion of the first conductive layer 112 over the removed first photoresist layer 113. Accordingly, a first conductive pattern 112P is formed on the substrate 101. The first photoresist layer 113 in this embodiment is preferably a negative photoresist—therefore, after the first development process, both of the first conductive layer 112 and the first photoresist layer 113 still remain in the regions irradiated by both of the first local exposure process and the first full exposure process, if the exposure doses of the first local exposure process and the first full exposure process are controlled and coordinated properly. On the other hand, in other regions, which have been irradiated only by the first full exposure process but were covered by the patterns of the first mask in the first local exposure process, only a portion of the first photoresist layer 113 remains after the first development process, and the first conductive layer 112 within these regions may be removed after the first development process. In other words, a thickness of the first photoresist layer 113 that is not covered by the first conductive pattern 112P is thinner than a thickness of the first photoresist layer 113 that is covered by the first conductive pattern 112P, but not limited thereto. In this embodiment, the first photoresist layer 113 remains in the regions that are not covered by the first conductive pattern 112P on the substrate 101, thereby promoting the overall external appearance. The light source 191 in the first exposure process may preferably include an ultraviolet light source, but the present invention is not limited to this and the type and the power of the light source 191 may be modified according to the photoresist material property of the first photoresist layer 113.

As shown in FIG. 6, the method of fabricating the touch panel in this embodiment may further include forming a second photosensitive conductive film 120 on the substrate 101. The second photosensitive conductive film 120 overlaps the first conductive pattern 112P in the direction Z perpendicular to the substrate 101. The second photosensitive conductive film 120 includes a second photoresist layer 123, a second conductive layer 122, and a second release film 121. The second conductive layer 122 is disposed on the second photoresist layer 123. The second release film 121 is disposed on the second conductive layer 122. In other words, the second conductive layer 122 is disposed between the second release film 121 and the second photoresist layer 123. The second photoresist layer 123 is disposed between the substrate 101 and the second conductive layer 122. It is worth noting that, as shown in FIGS. 3-6, both of the first photosensitive conductive film 110 and the second photosensitive conductive film 120 in this embodiment are formed on the same side of the upper surface 101A of the substrate 101. Nevertheless, the present invention is not limited to this—the first photosensitive conductive film 110 and the second photosensitive conductive film 120 may be formed on the same side or on the opposite sides of the substrate 101 according to other considerations. The arrangement and the material property of each layer of the second photosensitive conductive film 120 in this embodiment are similar to those of the photosensitive conductive film 10 in the embodiment detailed above and will not be redundantly described.

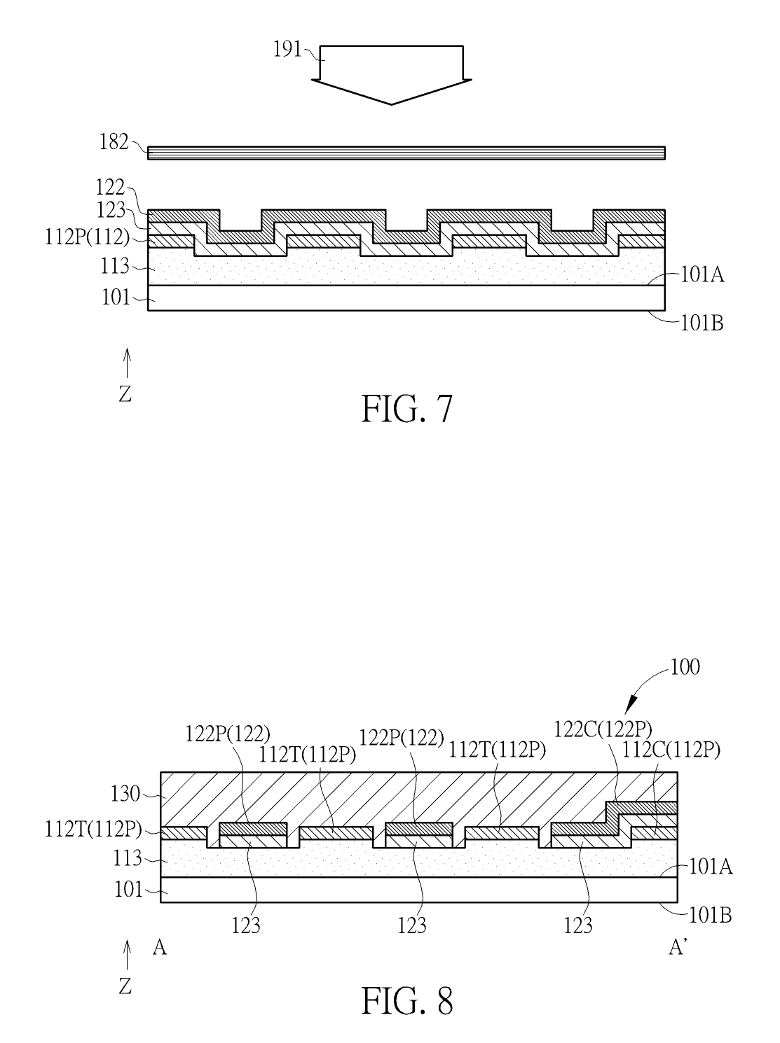

After the second photosensitive conductive film 120 is formed, a second exposure process and a second development process are carried out in that order. The second exposure process in this embodiment preferably includes a second local exposure process. As shown in FIG. 7, the second local exposure process is carried out with a second mask 182 and the light source 191. It is worth noting that, in the fabrication method of this embodiment, the second release film (not shown in FIG. 7) is preferably removed before the second exposure process is carried out, but not limited thereto. As shown in FIG. 8, the second development process is performed to remove a portion of the second photoresist layer 123 and a portion of the second conductive layer 122 that is on the removed second photoresist layer 123. Accordingly, a second conductive pattern 122P is formed on the substrate 101. Because the second exposure process does not include a full exposure process, the second photoresist layer 123 in the regions of the substrate 101 that are covered by the second conductive pattern 122P may not remain preferably, but not limited thereto.

After the steps detailed above, the touch panel 100 as shown in FIG. 8 and FIG. 9 may be formed. As shown in FIG. 8 and FIG. 9, the touch panel 100 includes the substrate 101, the first conductive pattern 112P, the first photoresist layer 113, the second conductive pattern 122P, and the second photoresist layer 123. The first conductive pattern 112P is disposed on the substrate 101. The first conductive pattern 112P includes a plurality of first axis electrodes 112X extending along a first direction X. The first photoresist layer 113 is disposed between the substrate 101 and the first conductive pattern 112P, and the first photoresist layer 113 completely covers the first conductive pattern 112P along the direction Z perpendicular to the substrate 101. The second conductive pattern 122P is disposed on the substrate 101. The second conductive pattern 122P includes a plurality of second axis electrodes 122Y extending along a second direction Y, and the second axis electrodes 122Y are electrically isolated from the first axis electrodes 112X. The second photoresist layer 123 is disposed between the substrate 101 and the second conductive pattern 122P. The second photoresist layer 123 completely covers the second conductive pattern 122P along the direction Z perpendicular to the substrate 101. In this embodiment, the first conductive pattern 112P, the first photoresist layer 113, the second conductive pattern 122P, and the second photoresist layer 123 are disposed on a side of the upper surface 101A of the substrate 101, but not limited thereto.

The first axis electrodes 112X are formed from the first conductive pattern 112P and the second axis electrodes 122Y are formed from the second conductive pattern 122P. More specifically, each of the first axis electrodes 112X includes a plurality of first electrodes 112T and a plurality of first connecting electrodes 112C. Each of the second axis electrodes 122Y includes a plurality of second electrodes 122T and a plurality of second connecting electrodes 122C. The first electrodes 112T are aligned along the first direction X. Each of the first connecting electrodes 112C is disposed between two of the first electrodes 112T disposed adjacent to each other along the first direction X so as to electrically connect the two first electrodes 112T. The second electrodes 122T are aligned along the second direction Y. Each of the second connecting electrodes 122C is disposed between two of the second electrodes 122T disposed adjacent to each other along the second direction Y so as to electrically connect the two second electrodes 122T. Because the second photoresist layer 123 exists in the overlapping region between the first conductive pattern 112P and the second conductive pattern 122P in the direction Z, and because the second photoresist layer 123 is interposed between the first conductive pattern 112P and the second conductive pattern 122P, the second photoresist layer 123 may be used to electrically isolate the first conductive pattern 112P from the second conductive pattern 122P. In this way, the first axis electrodes 112X are electrically isolated from the second axis electrodes 122Y. In other words, at least a portion of the first conductive pattern 112P is disposed between the second photoresist layer 123 and the substrate 101. Moreover, the thickness of the first photoresist layer 113 that is not covered by the first conductive pattern 112P is thinner than or equal to the thickness of the first photoresist layer 113 that is covered by the first conductive pattern 112P, but not limited thereto. In this embodiment, the second conductive pattern 122P completely covers the second photoresist layer 123 along the direction Z perpendicular to the substrate 101. Because both the second photoresist layer 123 that electrically isolates the first conductive pattern 112P from the second conductive pattern 122P, and the second conductive pattern 122P are formed simultaneously from the second photosensitive conductive film 120, there is no need to form an insulation layer. Therefore, the fabrication process is simplified, the size is miniaturized and the overall yield will not be affected by process variations of the insulation layer. In addition, each of the first electrodes 112T and each of the first connecting electrodes 112C can both be formed from the first conductive pattern 112P; each of the second electrodes 122T and each of the second connecting electrodes 122C can both be formed from the second conductive pattern 122P. There is no need for a bridge structure, and therefore the fabrication steps and the structure of the display panel 100 are simplified. A plurality of first wires 112R and a plurality of second wires 122R, furthermore, may be respectively formed from the first conductive pattern 112P and the second conductive pattern 122P. The first wires 112R and the second wires 122R are respectively electrically connected to the first axis electrodes 112X and the second axis electrodes 122Y for touch signal transmission.

The touch panel 100 of this embodiment may further include a covering layer 130. The covering layer 130 is disposed on the substrate 101. The covering layer 130 is used to cover the first conductive pattern 112P and the second conductive pattern 122P. The refractive index of the covering layer 130 is lower than the refractive index of the first conductive pattern 112P and the refractive index of the second conductive pattern 122P. In this embodiment, the first conductive pattern 112P and the second conductive pattern 122P are preferably made of transparent conductive materials, such as indium zinc oxide, indium tin oxide and aluminum zinc oxide, but not limited thereto. Moreover, the covering layer 130 is preferably made of organic materials, such as polyimide and acrylic resin, and inorganic materials, such as silicon nitride, silicon oxide, silicon oxynitride and titanium oxide, and a single-layered structure thereof or a composite-layer structure thereof. However, the present invention is not limited to this and the material of the covering layer 130 may be further modified according to other considerations so as to obtain the required refractive index. With the covering layer 130, the disparities in reflectivity and chrominance between the regions of the substrate 101 with the first conductive pattern 112P disposed on and the regions of the substrate 101 without the first conductive pattern 112P disposed on can be improved. Similarly, thanks to the covering layer 130, the disparities in reflectivity and chrominance between the regions of the substrate 101 with and without the first conductive pattern 112P and the second conductive pattern 122p can be improved. The thickness of the covering layer 130 may be further modified according to the refractive index and the thickness of both the first conductive pattern 112P and the second conductive pattern 122P.

In this embodiment, because both of the first conductive pattern 112P and the second conductive pattern 122P are formed from the combination of the photosensitive conductive films and formed by the corresponding exposure processes and the corresponding development processes, the touch panel 100 can be accomplished even without a film deposition process of a transparent conductive layer at high temperature. In other words, the method for fabricating the touch panel in this embodiment may be regarded as a low temperature process—it is substantially below 200 degrees Celsius, but not limited thereto. Therefore, the substrate 101 in this embodiment may include a hard substrate, such as a glass substrate and a ceramic substrate, a flexible substrate, such as a plastic substrate, or other kinds of substrates which are not suitable for a high temperature processes. In other words, the choice range of the substrate becomes wider. Besides, the substrate 101 may include a rigid cover substrate, a flexible cover substrate, a thin glass substrate or a substrate of a display device. The substrate of the above-mentioned display device may be a color filter substrate of a liquid crystal display device or an encapsulation cover substrate of an organic light emitting display device.

It is worth noting that the touch panel 100 in preceding embodiment includes a plurality of axis electrodes alternately stacked. However, in other embodiments, single-layered conductive patterns, which are not alternately stacked, may be formed by use of the methods for fabricating the conductive patterns of the present invention, so as to obtain touch panels of other driving types.

The touch panels of the display panels of the present invention and the fabrication methods thereof are not restricted to the preceding embodiments. Other embodiments or modifications will be detailed in the following description. In order to simplify and show the differences or modifications between the following embodiments and the above-mentioned embodiment, the same numerals denote the same components in the following description, and the similar parts are not detailed redundantly.

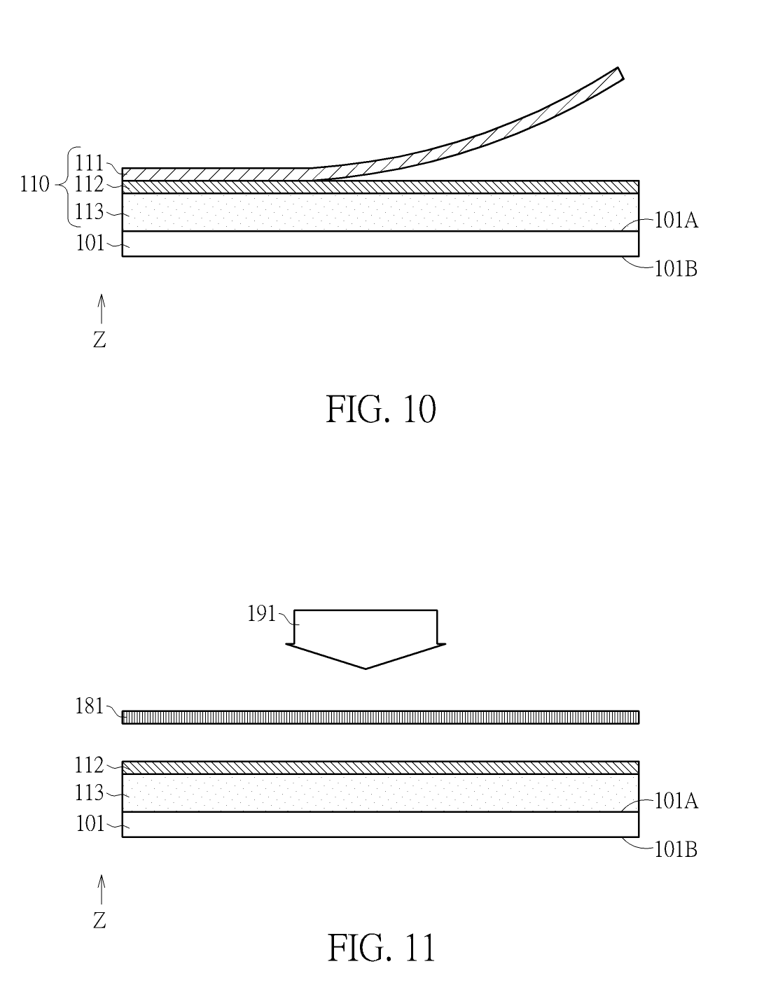

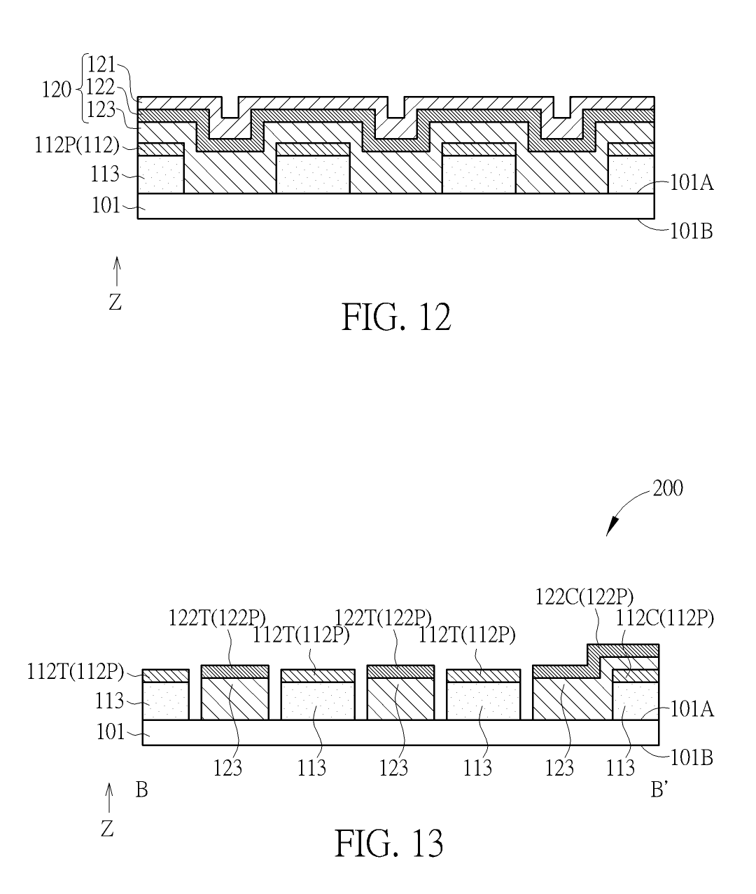

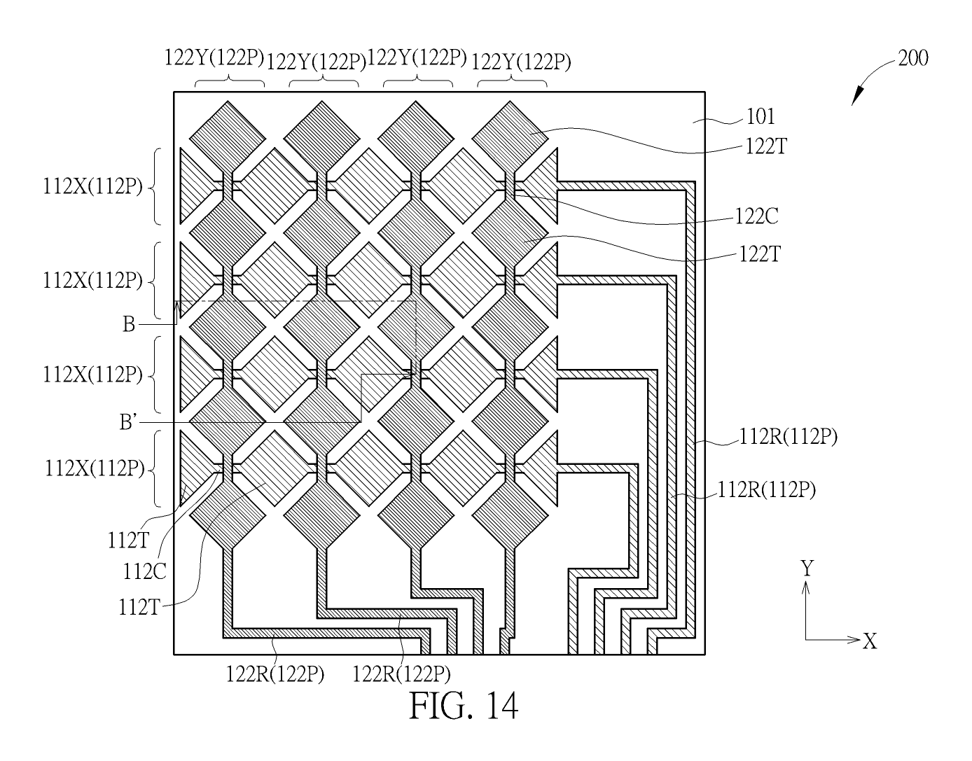

Please refer to FIGS. 10-14. FIGS. 10-14 are schematic diagrams illustrating a method for fabricating a touch panel according to a second embodiment of the present invention. FIGS. 10-13 are lateral-view schematic diagrams and FIG. 14 is a top-view schematic diagram. FIG. 13 may be regarded as a cross-sectional view diagram taken along a cross-sectional line B-B′ in FIG. 14. As shown in FIGS. 10-11, the difference between the method for fabricating the touch panel in this embodiment and that in the preceding first embodiment is that the first release film 111 is removed before the first exposure process. The first exposure process in this embodiment only includes the first local exposure process with the light source 191 and the first mask 181; in other words, there is no first full exposure process carried out on the first photoresist layer 113 and the first conductive layer 112 in the fabrication method of this embodiment. As shown in FIG. 12, after the first development process, a portion of the first conductive layer 112 and a portion of the first photoresist layer 113 are removed to form the first conductive pattern 112P on the substrate 101. The difference between this embodiment and the preceding first embodiment is that the first photoresist layer 113 preferably remains only between the first conductive pattern 112P and the substrate 101 after the first development process. Then, a second photosensitive conductive film 120 is formed to cover the substrate 101 and the first conductive pattern 112P. As shown in FIG. 13, after performing the second exposure process and the second development process in sequence, a portion of the second conductive layer 122 and a portion of the second photoresist layer 123 are removed to form the second conductive pattern 122P on the substrate 101. Accordingly, the touch panel 200 as shown in FIGS. 13-14 is accomplished. The difference between the touch panel 200 of this embodiment and the touch panel 100 of the preceding first embodiment is that the first conductive pattern 112P completely covers the first photoresist layer 113 along the direction Z perpendicular to the substrate 101. In the touch panel 200 of this embodiment, apart from the first photoresist layer 113 remaining only between the first conductive pattern 112P and the substrate 101, the other components and material properties of the touch panel 200 in this embodiment are similar to those of the touch panel 100 in the preceding first embodiment and will not be redundantly described. It is also worth noting that a covering layer (not shown) may be disposed on the substrate 101 of the touch panel in this embodiment like in the first embodiment detailed above. The covering layer may cover the first conductive pattern 112P and the second conductive pattern 122p, thereby improving the disparities in reflectivity and chrominance between the regions of the substrate 101 with and without the first conductive pattern 112P and the second conductive pattern 122p disposed on. Similarly, the differences of both the reflectivity and the chrominance between the regions of the substrate 101 with the second conductive pattern 122P disposed on and the regions of the substrate 101 without the second conductive pattern 122P disposed on can also be improved.

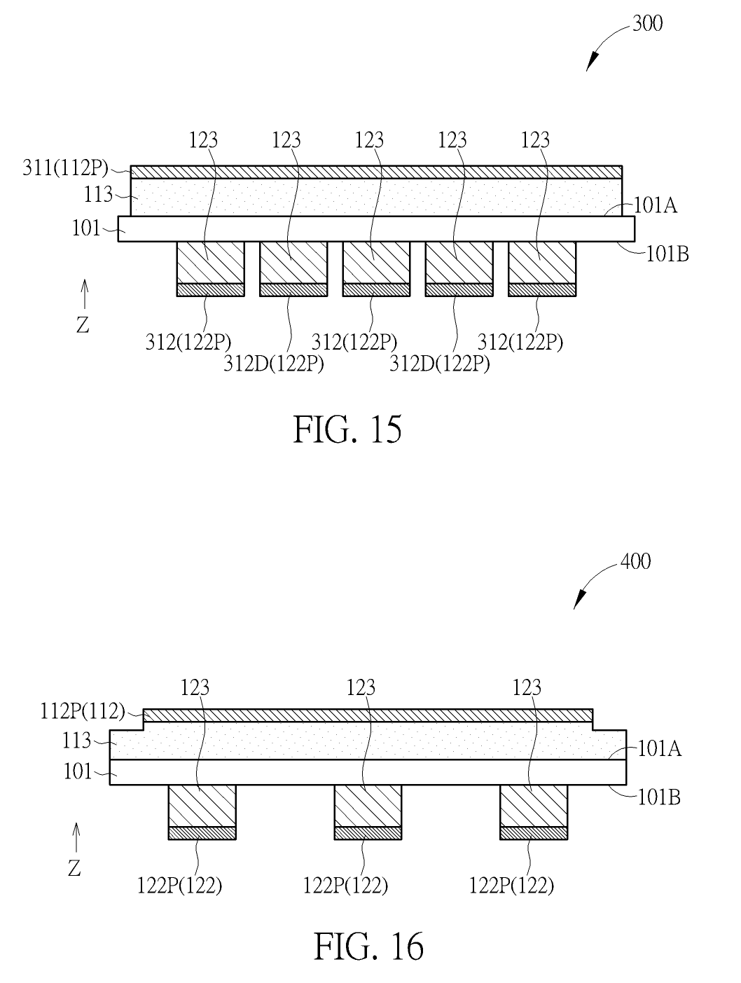

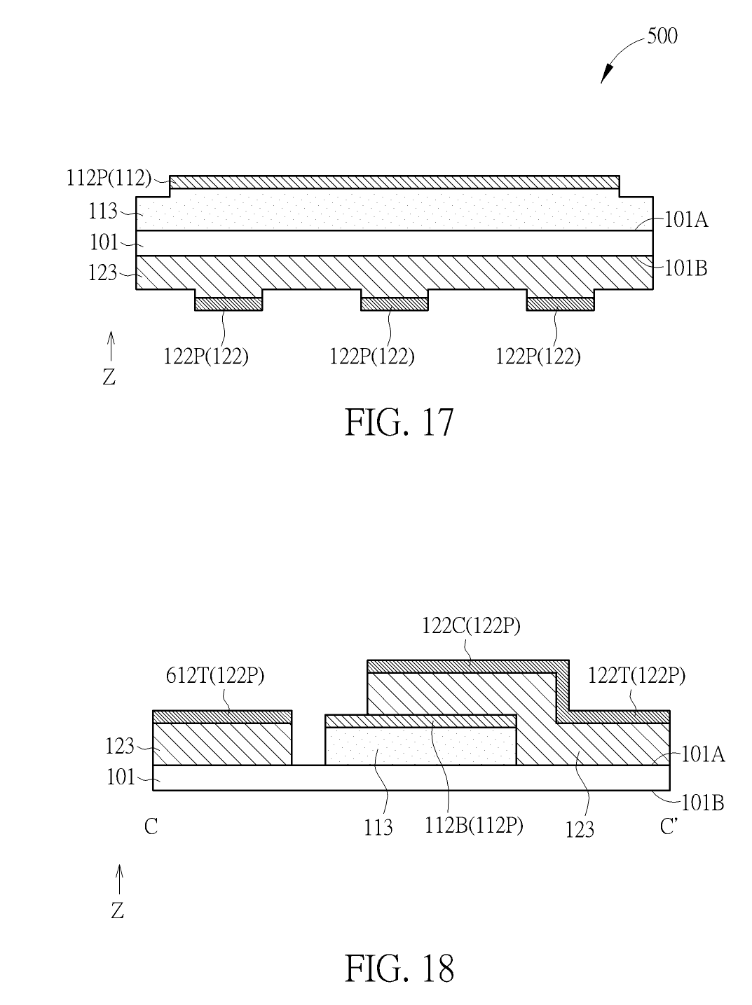

Please refer to FIGS. 15-17. FIG. 15 is a schematic diagram illustrating a method for fabricating a touch panel according to a third embodiment of the present invention. FIG. 16 is a schematic diagram illustrating a method for fabricating a touch panel according to a fourth embodiment of the present invention. FIG. 17 is a schematic diagram illustrating a method for fabricating a touch panel according to a fifth embodiment of the present invention. As shown in FIGS. 15-17, compared with the method of fabricating the touch panel of the preceding first embodiment, in the methods of fabricating a touch panel 300, a touch panel 400 and a touch panel 500, the first conductive pattern 112P is disposed on a side of the upper surface 101A of the substrate 101 while the second conductive pattern 122P is disposed on a side of the lower surface 101B of the substrate 101. The first conductive pattern 112P may or may not direct contact the upper surface 101A of the substrate 101. For example, when a buffer layer such as SiO2, SiNx layer, index matching layer or anti-reflective layer is formed on the upper surface 101A, the first conductive pattern 112P direct contact SiO2, SiNx layer, index matching layer or anti-reflective layer instead of the upper surface 101A. The second conductive pattern 122P may or may not direct contact the lower surface 101B of the substrate 101 with the same reason mention above. In other words, unlike the touch panel of the preceding first embodiment, the first photosensitive conductive film (not shown in FIGS. 15-17) is formed on a side of the upper surface 101A of the substrate 101 while the second photosensitive conductive film (not shown in FIGS. 15-17) is formed on a side of the lower surface 101B of the substrate 101. The touch panel 300 includes the substrate 101, the first conductive pattern 112P, the first photoresist layer 113, the second conductive pattern 122P and the second photoresist layer 123. The first conductive pattern 112P is disposed on a side of the upper surface 101A of the substrate 101. The first conductive pattern 112P includes a plurality of first axis electrodes 311. The first photoresist layer 113 is disposed between the first conductive pattern 112P and the substrate 101. The first photoresist layer 113 completely covers the first conductive pattern 112P along the direction Z perpendicular to the substrate 101. The second conductive pattern 122P is disposed on a side of the lower surface 101B of the substrate 101. The second conductive pattern 122P includes a plurality of second axis electrodes 312. The second axis electrodes 312 are electrically isolated from the first axis electrodes 311. The second photoresist layer 123 is disposed between the second conductive pattern 122P and the substrate 101. The second photoresist layer 123 completely covers the second conductive pattern 122P along the direction Z perpendicular to the substrate 101. In the touch panel 300, the first conductive pattern 112P completely covers the first photoresist layer 113 along the direction Z perpendicular to the substrate 101, and the second conductive pattern 122P completely covers the second photoresist layer 123 along the direction Z perpendicular to the substrate 101, but not limited thereto. In addition, in the touch panel 300, the second conductive pattern 122P may further include a plurality of dummy electrodes 312D. Each of the dummy electrodes 312D is preferably disposed between two second axis electrodes 312 so as to make the second axis electrodes 312 less distinct and improve the quality of the external appearance of the touch panel 300.

The touch panel 300, the touch panel 400 and the touch panel 500 can be regarded as touch panels with a double-sided transparent conductive layer, and may be so-called DITO (double ITO) touch panels, but not limited thereto. Moreover, the difference among the touch panel 300, the touch panel 400 and the touch panel 500 is that there is no full exposure process carried out in the method of fabricating the touch panel 300. Therefore, the first photoresist layer 113 only remains between the first conductive pattern 112P and the substrate 101; the second photoresist layer 123 only remains between the second conductive pattern 122P and the substrate 101. On the other hand, a first full exposure process is carried out in the first exposure process in the method of fabricating the touch panel 400. Therefore, the first photoresist layer 113 remains in the regions of the substrate 101 that are not covered by the first conductive pattern 112P. The thickness of the first photoresist layer 113 that is not covered by the first conductive pattern 112P is equal to or thinner than the thickness of the first photoresist layer 113 that is covered by the first conductive pattern 112P. In addition, in the method of fabricating the touch panel 500, there are preferably a second local exposure process and a second full exposure process performed on the second photoresist layer 123 and the second conductive layer 122 in the second exposure process. Besides, the second release film (not shown in FIG. 17) is preferably removed after the second local exposure process so that the second photoresist layer 123 of the touch panel 500 may still remain in the regions of the substrate 101 that are not covered by the second conductive pattern 122P. In other words, the thickness of the first photoresist layer 113 that is not covered by the first conductive pattern 112P is equal to or thinner than the thickness of the first photoresist layer 113 that is covered by the first conductive pattern 112P; the thickness of the second photoresist layer 123 that is not covered by the second conductive pattern 122P is equal to or thinner than the thickness of the second photoresist layer 123 that is covered by the second conductive pattern 122P. In the structure of the touch panel with the double-sided transparent conductive layer, according to other considerations, the exposure method may be modified to control the distribution of the first photoresist layer 113 and the second photoresist layer 123, thereby forming the required structure. It is worth noting that, in the methods of fabricating the touch panels of the third embodiment, the fourth embodiment and the fifth embodiment, according to other considerations, a covering layer (not shown) may also be formed on the upper surface 101A and the lower surface 101B of the substrate 101 respectively, so as to cover the first conductive pattern 112P and the second conductive pattern 122P. Therefore, the disparities in reflectivity and chrominance between the regions of the substrate 101 with and without the first conductive pattern 112P and the second conductive pattern 122p disposed on can be improved. Similarly, the disparities in reflectivity and chrominance between the regions of the substrate 101 with and without the first conductive pattern 112P and the second conductive pattern 122p disposed on can also be improved.

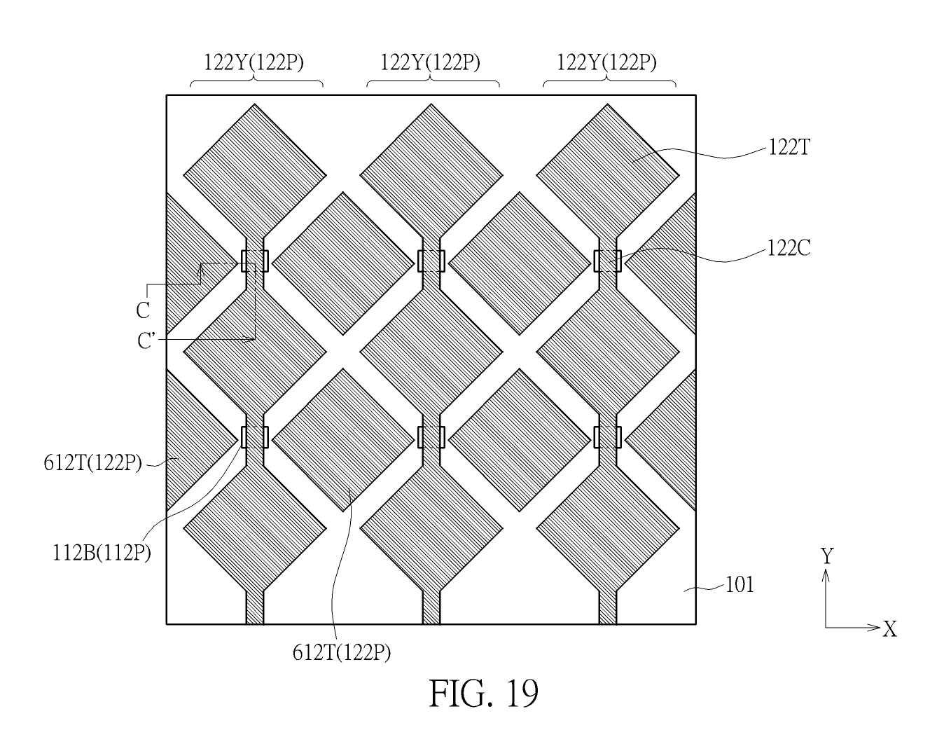

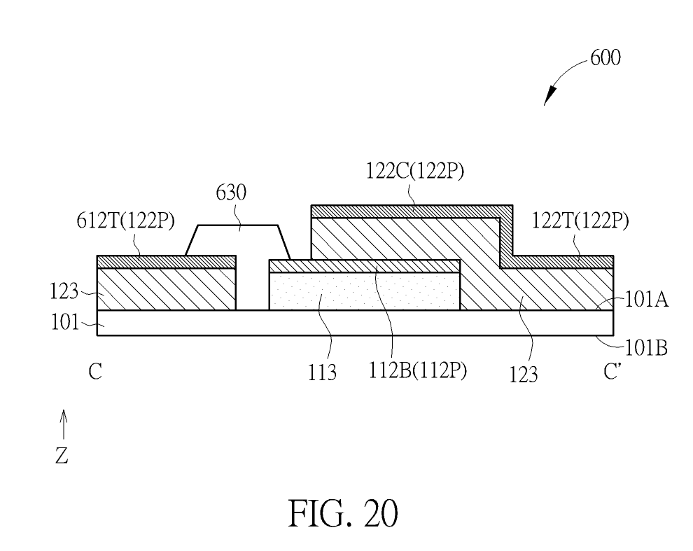

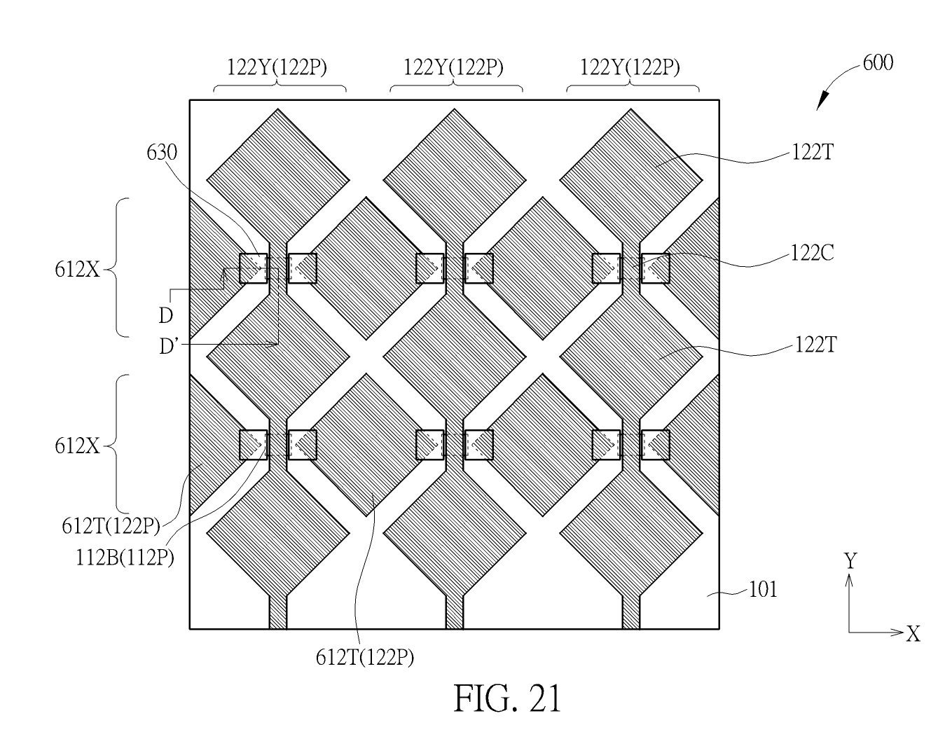

Please refer to FIGS. 18-21. FIGS. 18-21 are schematic diagrams illustrating a method for fabricating a touch panel according to a sixth embodiment of the present invention. FIG. 18 and FIG. 20 are lateral-view schematic diagram. FIG. 19 and FIG. 21 are top-view schematic diagrams. FIG. 18 may be regarded as a cross-sectional view diagram taken along a cross-sectional line C-C′ in FIG. 19. FIG. 20 may be regarded as a cross-sectional view diagram taken along a cross-sectional line D-D′ in FIG. 21. As shown in FIGS. 18-19, the difference between the method of fabricating the touch panel of this embodiment and that of the second embodiment is that the first conductive pattern 112P of this embodiment includes a plurality of bridge conductors 112B. The second conductive pattern 122P includes a plurality of second axis electrodes 122Y and a plurality of first electrodes 612T. The first electrodes 612T and the second axis electrodes 122Y are preferably formed from the second conductive pattern 122P. Because the second axis electrodes 122Y includes the second electrodes 122T and the second connecting electrodes 122C, the second electrodes 122T and the second connecting electrodes 122C are also preferably formed from the second conductive pattern 122P. On the other hand, the bridge conductors 112B are formed from the first conductive pattern 112P. Each of the bridge conductors 112B is used to electrically connect two of the adjacent first electrodes 612T in the first direction X. Because the second photoresist layer 123 is disposed in the overlapping region between the second conductive pattern 122P and each of the bridge conductors 112B in the direction Z perpendicular to the substrate 101, and because the second photoresist layer 123 is interposed between the second conductive pattern 122P and each of the bridge conductors 112B, the bridge conductors 112B are electrically isolated from the second axis electrodes 122Y by the second photoresist layer 123. To be more specifically, as shown in FIGS. 20 and 21, at least one connection line 630 is formed on the substrate 101 after forming the second conductive pattern 122P in the method for fabricating the touch panel of this embodiment. As a result, each of the bridge conductors 112B is electrically connected to the first electrodes 612T corresponding to the bridge conductor 112B through the connection line 630. The connection line 630 preferably contacts the first electrodes 612T and the bridge conductors 112B, which are not covered by both the second conductive pattern 122P and the second photoresist layer 123, so that the connection line 630 can electrically connect the first electrodes 612T to the bridge conductors 112B. However, the present invention is not limited to this and the first electrodes 612T may be electrically connected to the bridge conductors 112B by use of other appropriate approaches. Accordingly, a touch panel 600 as shown in FIGS. 20-21 may be accomplished after the above-mentioned steps.

In other words, the touch panel 600 includes a substrate 101, a first conductive pattern 112P, a first photoresist layer 113, a second conductive pattern 122P and a second photoresist layer 123. The first conductive pattern 112P is disposed on the substrate 101. The first conductive pattern 112P includes a plurality of bridge conductors 112B. The first photoresist layer 113 is disposed between the first conductive pattern 112P and the substrate 101. The first photoresist layer 113 completely covers the first conductive pattern 112P along the direction Z perpendicular to the substrate 101. The second conductive pattern 122P is disposed on the substrate 101. The second conductive pattern 122P includes a plurality of second axis electrodes 122Y and a plurality of first electrodes 612T. The bridge conductors 112B are electrically isolated from the second axis electrodes 122Y. Each of the bridge conductors 112B is electrically connected to at least one of the first electrodes 612T. The second photoresist layer 123 is disposed between the second conductive pattern 122P and the substrate 101. The second photoresist layer 123 completely covers the second conductive pattern 122P along the direction Z perpendicular to the substrate 101. In this embodiment, the first conductive pattern 112P, the first photoresist layer 113, the second conductive pattern 122P and the second photoresist layer 123 are disposed on a side of the upper surface 101A of the substrate 101, but not limited thereto. Moreover, the touch panel 600 may further include the connection line 630, which is disposed on the substrate 101. Each of the bridge conductors 112B is electrically connected to the corresponding first electrodes 612T through the connection line 630. In the touch panel 600, the first electrodes 612T, the bridge conductors 112B and the connection line 630 may be used to constitute a plurality of first axis electrodes 612X extending along the first direction X, but not limited thereto. Because both of the first electrodes 612T and the second electrodes 122T can be formed from the second conductive pattern 122P, the differences in the external appearance caused by forming the first electrodes 612T and the second electrodes 122T from different conductive layers, may be eliminated. Or, the bridge conductors 112B may be formed by other fabrication methods. The bridge conductors 112B overlap the second axis electrodes 122Y in the direction Z perpendicular to the substrate 101. The bridge conductors 112B and the first electrodes 612T constitute a plurality of first axis electrodes 612X extending along the first direction X, but not limited thereto.

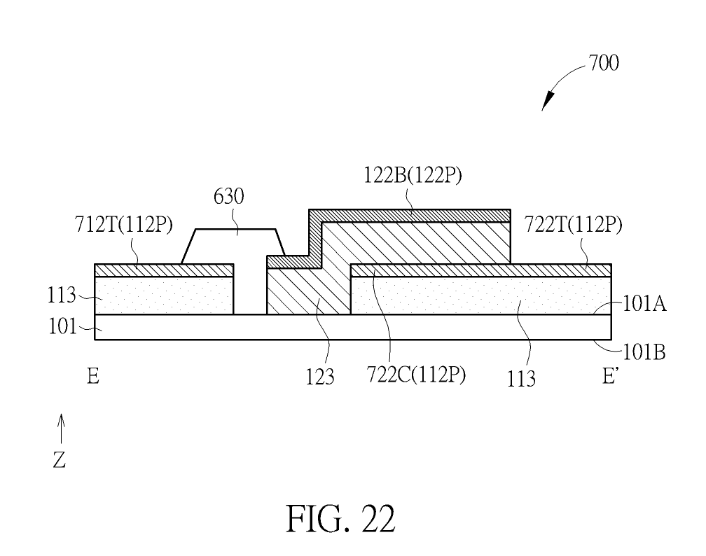

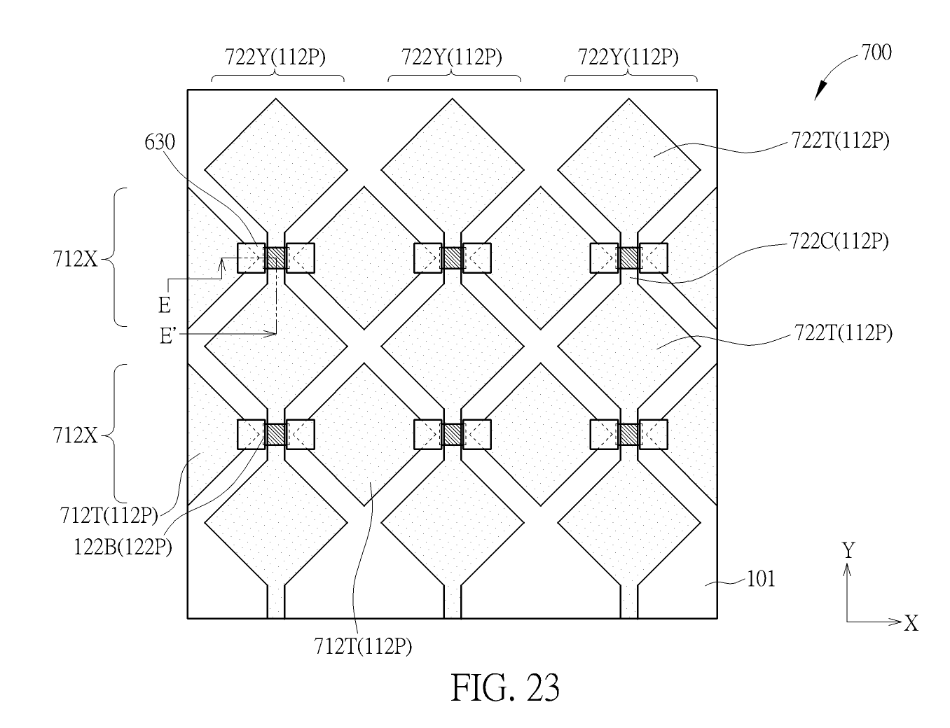

Please refer to FIGS. 22-23. FIGS. 22-23 are schematic diagrams illustrating a method for fabricating a touch panel according to a seventh embodiment of the present invention. FIG. 22 is a lateral-view schematic diagram. FIG. 23 is a top-view schematic diagram. FIG. 22 may be regarded as a cross-sectional view diagram taken along a cross-sectional line E-E′ in FIG. 23. As shown in FIGS. 22-23, the difference between the method of fabricating the touch panel of this embodiment and that of the sixth embodiment is that the second conductive pattern 122P in this embodiment includes a plurality of bridge conductors 122B. In addition, the first conductive pattern 112P includes a plurality of second axis electrodes 722Y and a plurality of first electrodes 712T. The first electrodes 712T and the second axis electrodes 722Y are preferably formed from the first conductive pattern 112P. Because the second axis electrodes 722Y include the second electrodes 722T and the second connecting electrodes 722C, the second electrodes 722T and the second connecting electrodes 722C are also preferably formed from the first conductive pattern 112P. Each of the bridge conductors 122B is disposed on each of the second connecting electrodes 722C. On the other hand, the bridge conductors 122B are formed from the second conductive pattern 122P. Each of the bridge conductors 122B is used to electrically connect two of the adjacent first electrodes 712T in the first direction X. Because the second photoresist layer 123 is disposed in the overlapping region between the first conductive pattern 112P and each of the bridge conductors 122B in the direction Z perpendicular to the substrate 101, and because the second photoresist layer 123 is interposed between the first conductive pattern 112P and each of the bridge conductors 122B, the bridge conductors 122B are electrically isolated from the second axis electrodes 722Y by the second photoresist layer 123. To be more specifically, as shown in FIGS. 22 and 23, at least one connection line 630 is formed on the substrate 101 after forming the second conductive pattern 122P in the method for fabricating the touch panel of this embodiment. As a result, each of the bridge conductors 122B is electrically connected to the first electrodes 712T corresponding to the bridge conductors 122B through the connection line 630. Accordingly, a touch panel 700 as shown in FIGS. 22-23 may be accomplished after the above-mentioned steps. In the touch panel 700, the first electrodes 712T, the bridge conductors 122B and the connection line 630 may be used to constitute a plurality of first axis electrodes 712X extending along the first direction X, but not limited thereto. Or, the bridge conductors 122B of this embodiment may also be conductors formed by other fabrication methods, but not limited thereto. It is also worth noting that, in the methods of fabricating the touch panels of the preceding sixth embodiment and the preceding seventh embodiment, according to other considerations, a covering layer (not shown) may also be formed on the substrate 101 so as to cover the first conductive pattern 112P and the second conductive pattern 122P. Therefore, the disparities in both reflectivity and chrominance between the regions of the substrate 101 with and without the first conductive pattern 112P and the second conductive pattern 122p disposed on can be improved. Similarly, the disparities in reflectivity and chrominance between the regions of the substrate 101 with and without the first conductive pattern 112P and the second conductive pattern 122p disposed on can also be improved.

In other embodiments, a plurality of first axis electrodes 311 may be formed from the photosensitive conductive film on the substrate 101. A plurality of second axis electrodes 312 may be formed from the transparent conductive layer on another transparent cover substrate after a patterning process. The materials of the transparent cover substrate may be plastic or glass, but not limited thereto.

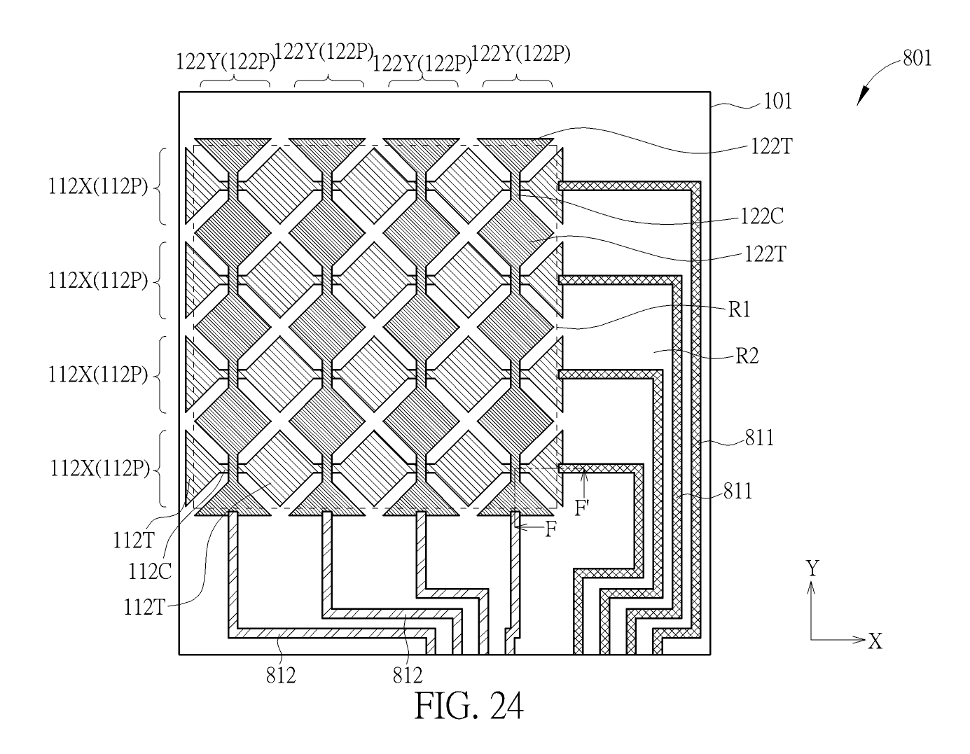

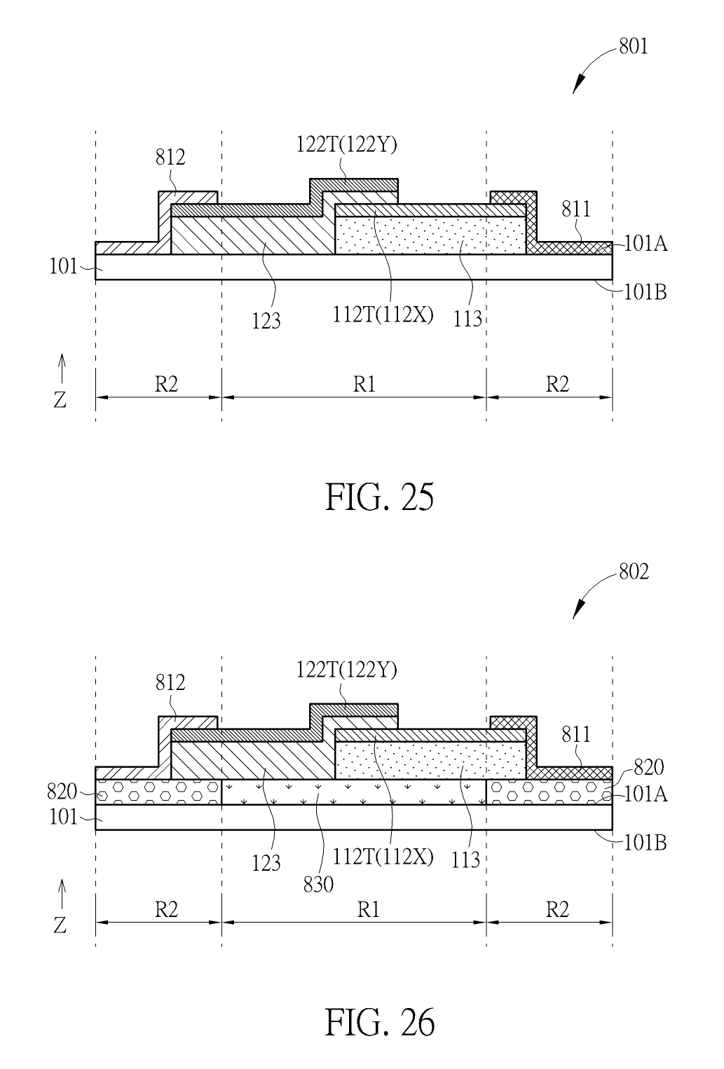

Please refer to FIGS. 24 and 25. FIG. 24 is a schematic diagram illustrating a touch panel according to an eighth embodiment of the present invention. FIG. 25 is a cross-sectional view diagram taken along a cross-sectional line F-F′ in FIG. 24. As shown in FIGS. 24 and 25, the embodiment provides a touch panel 801. The difference between the touch panel of the aforementioned second embodiment and that of this embodiment is that the touch panel 801 further includes a plurality of first wires 811 and a plurality of second wires 812 so as to respectively electrically connect to each of the first axis electrodes 112X and each of the second axis electrodes 122Y and transmit touch signals. Each of the first wires 811 is at least partially disposed on one of the first axis electrodes 112X to be electrically connected to the first axis electrode 112X. Each of the second wires 812 is at least partially disposed on one of the second axis electrodes 122Y to be electrically connected to the second axis electrode 122Y. The first wires 811 and the second wires 812 preferably include metal conductive materials, such as silver paste or other metal conductive materials with resistivity lower than that of the first conductive pattern 112P and the second conductive pattern 122P in order to improve the signal transmission performance of the wires on the periphery of the touch panel 801. The first wires 811 and the second wires 812 are preferably formed after the first axis electrodes 112X and the second axis electrodes 122Y are formed. The first wires 811 and the second wires 812 are preferably formed of the same material and in one step to simplify the related processes, but not limited thereto. In other words, the first wires 811 and the second wires 812 may be formed of different materials and/or in different steps according to different design considerations. Besides, the substrate 101 of this embodiment may include a transmissible region R1 and a peripheral region R2 disposed on at least one side of the transmissible region R1. The first axis electrodes 112X and the second axis electrodes 122Y are disposed on the transmissible region R1 and may partially extend to the peripheral region R2. The first wires 811 and the second wires 812 are disposed on the peripheral region R2, but not limited thereto. It is worth noting that the first wires 811 and the second wires 812 mentioned above may be integrated into other embodiments of the present invention according to different requirements in order to reduce the resistance of the trace lines on the periphery of the touch panel 801.

Please refer to FIG. 26. FIG. 26 is a schematic diagram illustrating a touch panel according to a ninth embodiment of the present invention. As shown in FIG. 26, the embodiment provides a touch panel 802. The difference between the touch panel of the aforementioned eighth embodiment and that of this embodiment is that the touch panel 802 further includes a decoration frame 820 and a filling layer 830 disposed on the substrate 101. The filling layer 830 is at least partially disposed in the transmissible region R1, and the decoration frame 820 is at least partially disposed in the peripheral region R2. In this embodiment, the transmissible region R1 and the peripheral region R2 of the substrate 101 may be regarded to be defined and divided by the decoration frame 820; namely, the portion with the decoration frame 820 is defined as the peripheral region R2, but not limited thereto. Preferably, the decoration frame 820 and the filling layer 830 are formed on the substrate 101 before the first photoresist layer 113, the first axis electrodes 112X, the second photoresist layer 123, the second axis electrodes 122Y, the first wires 811 and the second wires 812 are formed. In addition, the filling layer 830 is preferably formed after the decoration frame 820 is formed so as to fill the area of the substrate 101 without the decoration frame 820 so that negative effects, such as the severely uneven surface caused by the thickness of the decoration frame 820 in the subsequent processes, can be improved. The filling layer 830 preferably includes acrylic ester derivative or other suitable transparent filling materials, such as transparent resin. Moreover, the refractive index of the filling layer 830 is preferably the same as or similar to that of the photoresist layers, which are the first photoresist layer 113 and the second photoresist layer 123 in this embodiment, so as to make the first conductive pattern and the second conductive pattern less visible, but not limited thereto.

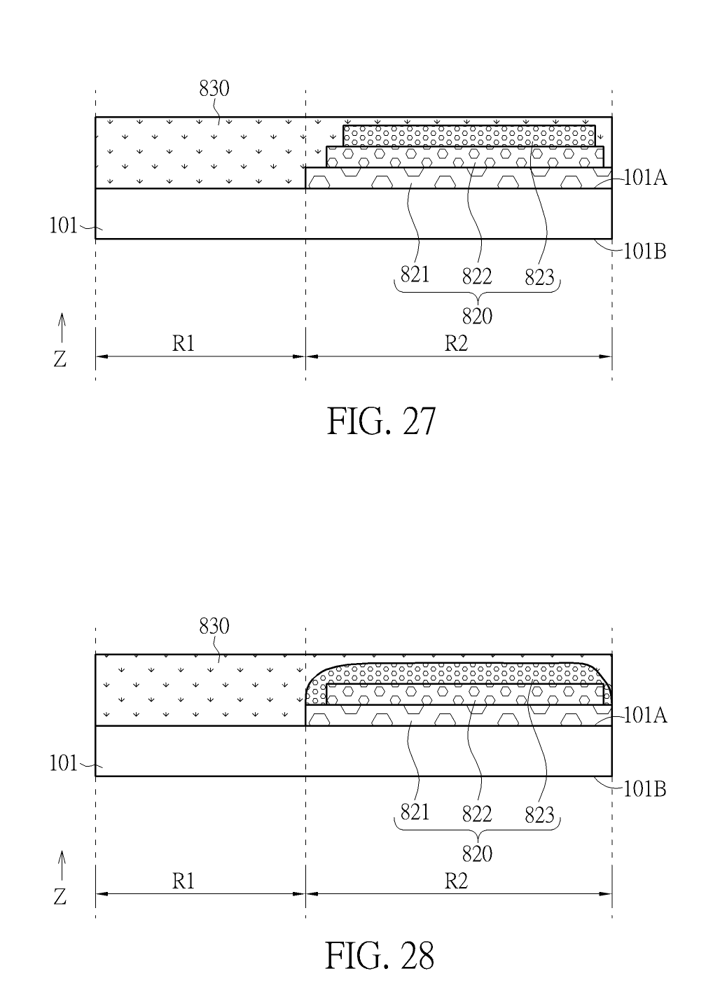

In order to further illustrate the features of the decoration frame 820 and the filling layer 830, please refer to FIGS. 27 and 28, and also refer to FIG. 26. FIG. 27 is a schematic diagram illustrating a decoration frame of a touch panel according to an embodiment of the present invention. FIG. 28 is a schematic diagram illustrating a decoration frame of a touch panel according to another embodiment of the present invention. As shown in FIG. 27, the filling layer 830 may extend to the peripheral region R2 and at least partially cover the decoration frame 820 in order to further ensure the planarization result formed by the filling layer 830, but not limited thereto. In addition, according to different design considerations, the decoration frame 820 may include a first decoration layer 821 and a second decoration layer 822 disposed on along the direction Z perpendicular to the substrate 101, and the first decoration layer 821 is disposed between the second decoration layer 822 and the substrate 101. The first decoration layer 821 and the second decoration layer 822 may be respectively selected from a black decoration layer or a non-black decoration layer, such as a white decoration layer, so as to provide the desired decoration effects on the lower surface 101B of the substrate 101. In this embodiment, the pattern range of the first decoration layer 821 is preferably greater than the pattern range of the second decoration layer 822 to adapt for common printing processes of forming decoration layer, but not limited thereto. The pattern range of the second decoration layer 822 may be greater than the pattern range of the first decoration layer 821 in other embodiments of the present invention. Besides, according to different design considerations, the decoration frame 820 of this embodiment may further include a third decoration layer 823 disposed on the second decoration layer 822 so as to provide the desired decoration effects according to the first decoration layer 821 and the second decoration layer 822. In this embodiment, the pattern range of the second decoration layer 822 may be greater than the pattern range of the third decoration layer 823, but not limited thereto. As shown in FIG. 28, in another embodiment of the present invention, the third decoration layer 823 may also cover the second decoration layer 822 along the direction Z perpendicular to the substrate 101 according to different design considerations. It is worth noting that the touch panel of the present invention may further include a shielding layer (not shown) disposed on the decoration frame 820 in the peripheral region R2 according to different design considerations in order to compensate insufficient optical density (OD) issues when the decoration frame 820 is composed of an non-black decoration layer, but not limited thereto. Besides, it is worth noting that since the filling layer 830 of this embodiment can extend to the peripheral region R2 and cover the decoration frame 820, negative effects, such as the severely uneven surface on the periphery when the decoration frame 820 is composed of multiple decoration layers, can be improved, thereby bringing flexibility to the design and manufacturing processes of the decoration frame 820.

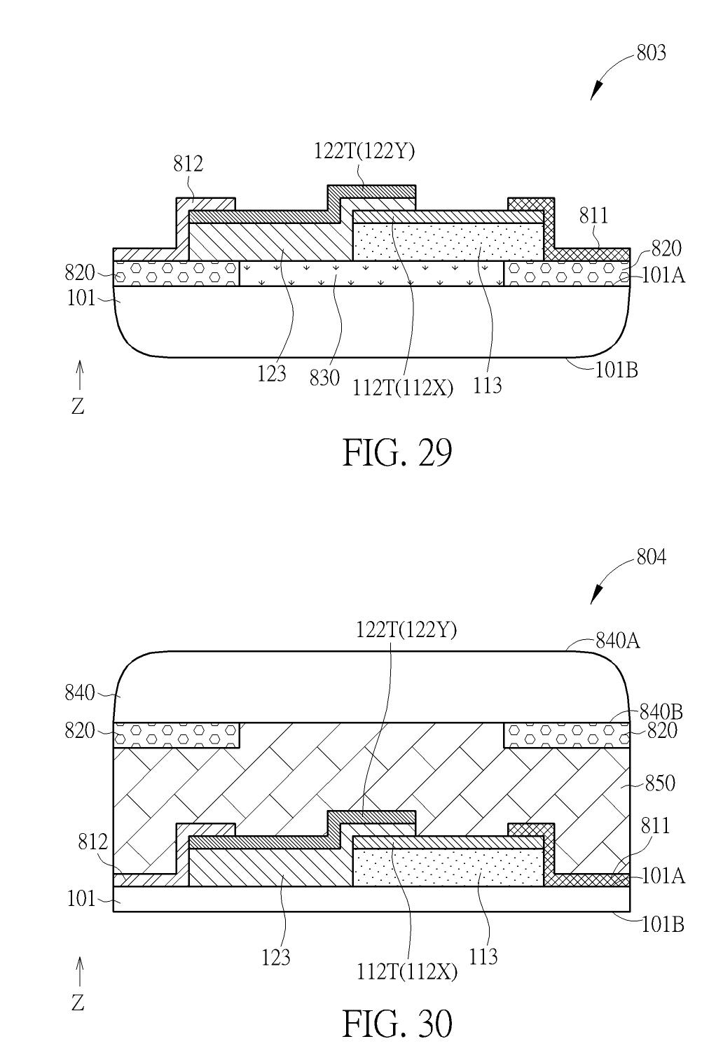

Please refer to FIG. 29. FIG. 29 is a schematic diagram illustrating a touch panel according to a tenth embodiment of the present invention. As shown in FIG. 29, the difference between the touch panel of the aforementioned ninth embodiment and that of this embodiment is that the substrate 101 in the touch panel 803 may be a cover substrate. Moreover, the substrate 101 can be a plane, a curved surface or the combination thereof, such as a 2.5D glass, but not limited thereto. For example, the lower surface 101B of the substrate 101 in this embodiment may be a curved surface in order to present the particular exterior. Of course, in other embodiments, the upper surface 101A of the substrate 101 may be a curved surface or an irregular surface. In other cases, both the upper surface 101A and the lower surface 101B may be curved surfaces or irregular surfaces.

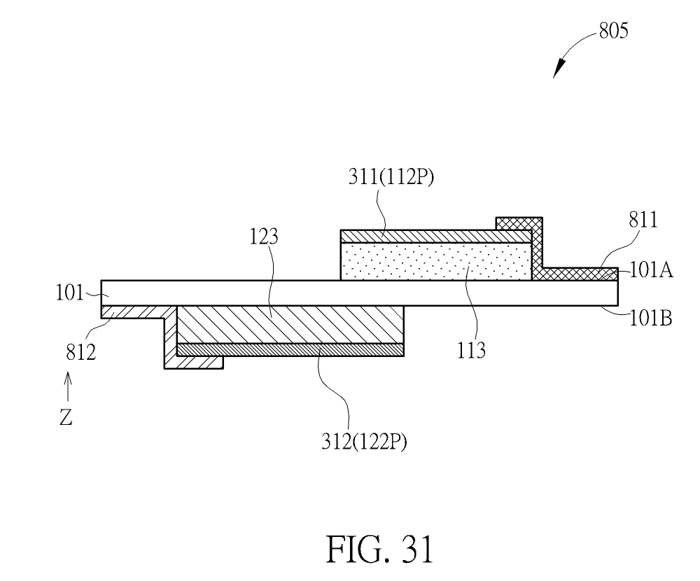

Please refer to FIG. 30. FIG. 30 is a schematic diagram illustrating a touch panel according to an eleventh embodiment of the present invention. As shown in FIG. 30, the difference between the touch panel of the aforementioned ninth embodiment and that of this embodiment is that the touch panel 804 of this embodiment further includes a cover substrate 840 and an adhesion layer 850. The cover substrate 840 is disposed corresponding to the substrate 101. The adhesion layer 850 is disposed between the cover substrate 840 and the substrate 101 so as to adhere the cover substrate 840 and the substrate 101. It is worth noting that, in this embodiment, the upper surface 101A of the substrate 101 faces a lower surface 840B of the cover substrate 840 so as to be combined; however, in other embodiments of the present invention, the lower surface 101B of the substrate 101 (the lower surface 101B without the first axis electrodes 112X and the second axis electrodes 122Y formed) may be adhered to the cover substrate 840 with the adhesion layer 850. Also, as shown in FIG. 8, a covering layer 130 may be first formed to cover the first axis electrodes 112X and the second axis electrodes 122Y and then adhered to the cover substrate 840 with the adhesion layer 850. It is worth noting that the cover substrate 840 of this embodiment may be a hard cover substrate or a soft cover substrate. The upper surface 840A or/and the lower surface 840B of the cover substrate 840 may be curved surfaces in order to present the particular exterior, but not limited thereto. In other embodiments of the present invention, both the upper surface and the lower surface may be flat cover substrates according to different design considerations. Furthermore, the upper surface 840A of the cover substrate 840 may be the surface of the touch panel 804 for users to touch. The decoration frame 820 may be disposed on the lower surface 840B of the cover substrate 840, but not limited thereto.

Please refer to FIG. 31. FIG. 31 is a schematic diagram illustrating a touch panel according to a twelfth embodiment of the present invention. As shown in FIG. 31, the embodiment provides a touch panel 805. The difference between the touch panel of the aforementioned third embodiment and that of this embodiment is that the touch panel 805 further includes at least one first wire 811 and at least one second wire 812 so as to respectively electrically connect to each of the first axis electrodes 311 and each of the second axis electrodes 312 and transmit touch signals. The first wire 811 is at least partially disposed on one of the first axis electrodes 311 to be electrically connected to the first axis electrode 311. The second wire 812 is at least partially disposed on one of the second axis electrodes 312 to be electrically connected to the second axis electrode 312. In other words, the first wire 811 is disposed in a side of the upper surface 101A of the substrate 101, and the second wire 812 is disposed in a side of the lower surface 101B of the substrate 101. The first wire 811 and the second wire 812 preferably include metal conductive materials, such as silver paste or other metal conductive materials with resistivity lower than that of the first conductive pattern 112P and the second conductive pattern 122P in order to improve the signal transmission performance of the wires on the periphery of the touch panel 805.

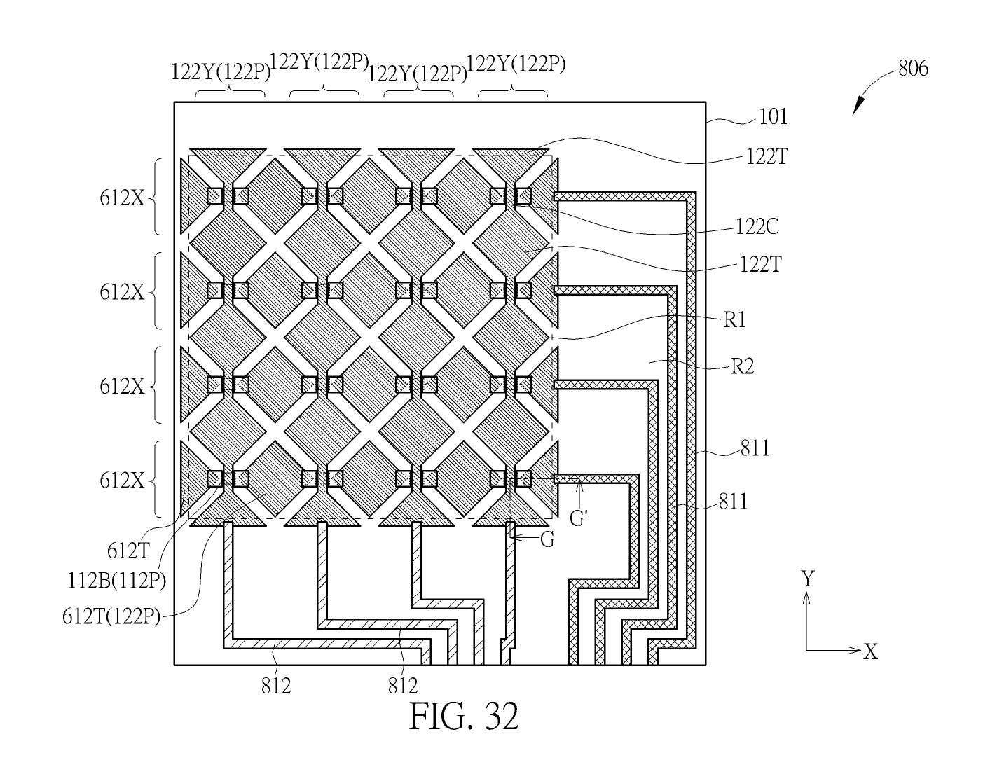

Please refer to FIGS. 32 and 33. FIG. 32 is a schematic diagram illustrating a touch panel according to a thirteenth embodiment of the present invention. FIG. 33 is a cross-sectional view diagram taken along a cross-sectional line G-G′ in FIG. 32. As shown in FIGS. 32 and 33, the embodiment provides a touch panel 806. The difference between the touch panel of the aforementioned sixth embodiment and that of this embodiment is that the touch panel 806 further includes a plurality of first wires 811 and a plurality of second wires 812 so as to respectively electrically connect to each of the first axis electrodes 612X and each of the second axis electrodes 122Y and transmit touch signals. Each of the first wires 811 is at least partially disposed on one of the first axis electrodes 612T to be electrically connected to the first axis electrode 612T and the first axis electrode 612X. Each of the second wires 812 is at least partially disposed on one of the second axis electrodes 122Y to be electrically connected to the second axis electrode 122Y. The first wires 811 and the second wires 812 preferably include metal conductive materials, such as silver paste or other metal conductive materials with resistivity lower than that of the first conductive pattern 112P and the second conductive pattern 122P in order to improve the signal transmission performance of the wires on the periphery of the touch panel 806. The first wires 811 and the second wires 812 are preferably formed after the second axis electrodes 122Y are formed. The first wires 811 and the second wires 812 are preferably formed of the same material and in one step to simplify the related processes, but not limited thereto. What's more, if the material of the connection line 630 is the same as that of the first wires 811 and the second wires 812, the connection line 630, the first wires 811 and the second wires 812 may be formed simultaneously in the same process according to different considerations so as to further simplify manufacturing processes, but not limited thereto. Besides, the substrate 101 of this embodiment may include a transmissible region R1 and a peripheral region R2 disposed in at least one side of the transmissible region R1. The first axis electrodes 612X and the second axis electrodes 122Y are disposed on the transmissible region R1 and may partially extend to the peripheral region R2. The first wires 811 and the second wires 812 are disposed on the peripheral region R2, but not limited thereto. It is worth noting that the first wires 811 and the second wires 812 of this embodiment may be disposed in the manner similar to that in the seventh embodiment mentioned above according to different considerations.

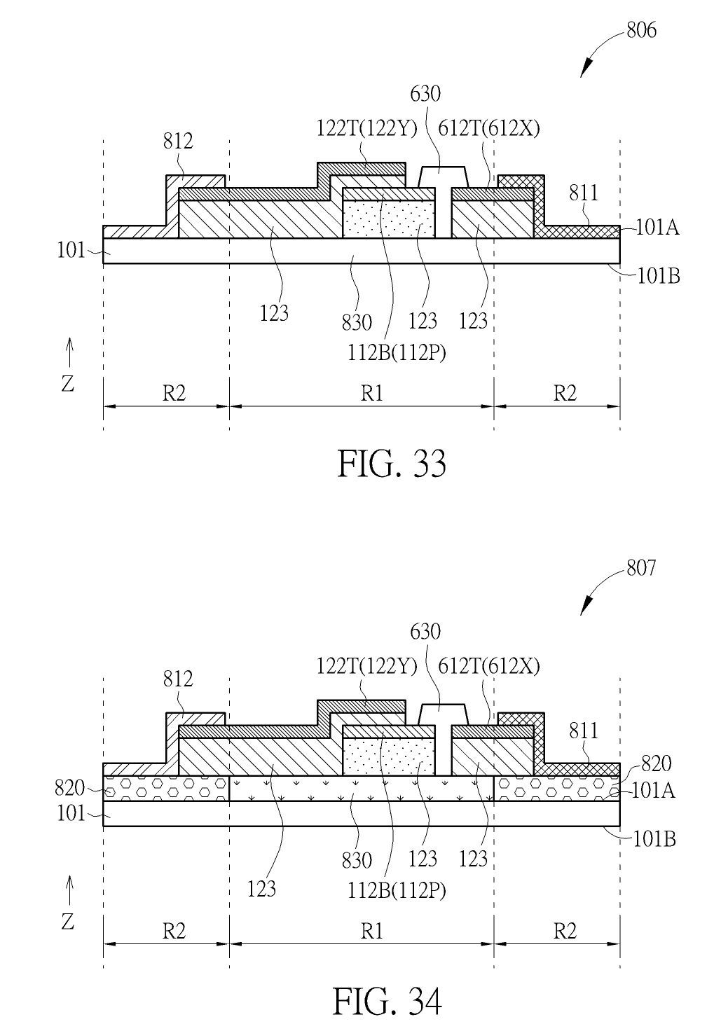

Please refer to FIG. 34. FIG. 34 is a schematic diagram illustrating a touch panel according to a fourteenth embodiment of the present invention. As shown in FIG. 34, the embodiment provides a touch panel 807. The difference between the touch panel of the aforementioned thirteenth embodiment and that of this embodiment is that the touch panel 807 further includes a decoration frame 820 and a filling layer 830 disposed on the substrate 101. The filling layer 830 is at least partially disposed in the transmissible region R1, and the decoration frame 820 is at least partially disposed in the peripheral region R2. Preferably, the decoration frame 820 and the filling layer 830 are formed on the substrate 101 before the first photoresist layer 113, the first axis electrodes 612X, the second photoresist layer 123, the second axis electrodes 122Y, the first wires 811 and the second wires 812 are formed. In addition, the filling layer 830 is preferably formed after the decoration frame 820 is formed so as to fill the area of the substrate 101 without the decoration frame 820 so that negative effects, such as the severely uneven surface caused by the thickness of the decoration frame 820 in the subsequent processes, can be improved. The filling layer 830 preferably includes acrylic ester derivative or other suitable transparent filling materials, such as transparent resin. Moreover, the refractive index of the filling layer 830 is preferably the same as or similar to that of the photoresist layers so as to make the conductive patterns less distinct, but not limited thereto. Besides, it is worth noting that, as shown in FIG. 27, the filling layer 830 of this embodiment can extend to the peripheral region R2 and cover the decoration frame 820, thereby further ensuring the planarization result formed by the filling layer 830, but not limited thereto. The features of the decoration frame 820 of this embodiment are illustrated in the above-mentioned embodiments with details, and the identical features will not be redundantly described.

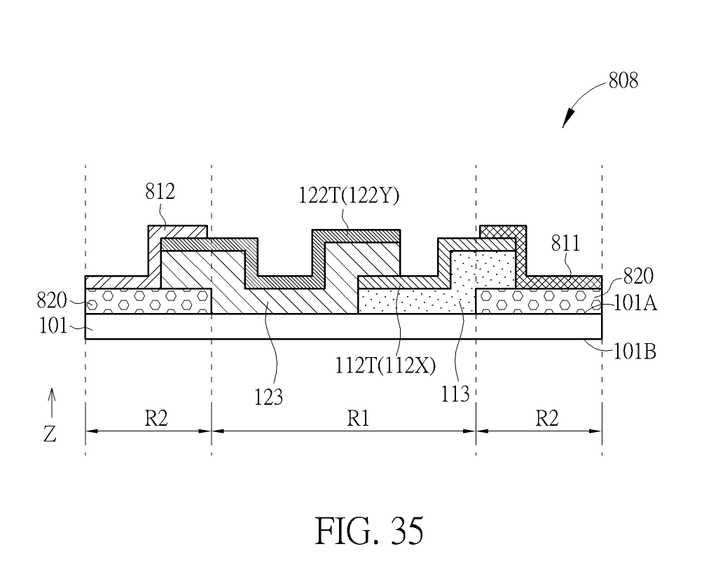

Please refer to FIG. 35. FIG. 35 is a schematic diagram illustrating a touch panel according to a fifteenth embodiment of the present invention. As shown in FIG. 35, the embodiment provides a touch panel 808. The difference between the touch panel of the aforementioned ninth embodiment and that of this embodiment is that the filling layer is not disposed in the touch panel 808. Therefore, the first photoresist layer 113 and the second photoresist layer 123 are directly disposed in the transmissible region R1 on the substrate 101, but not limited thereto.

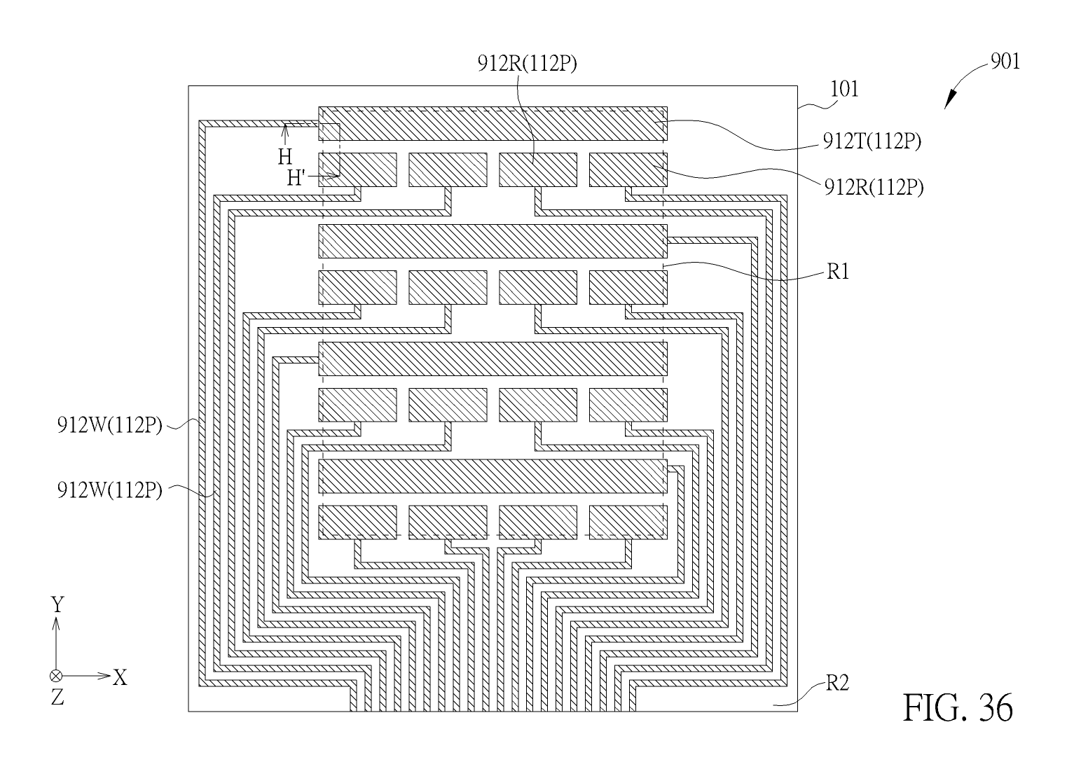

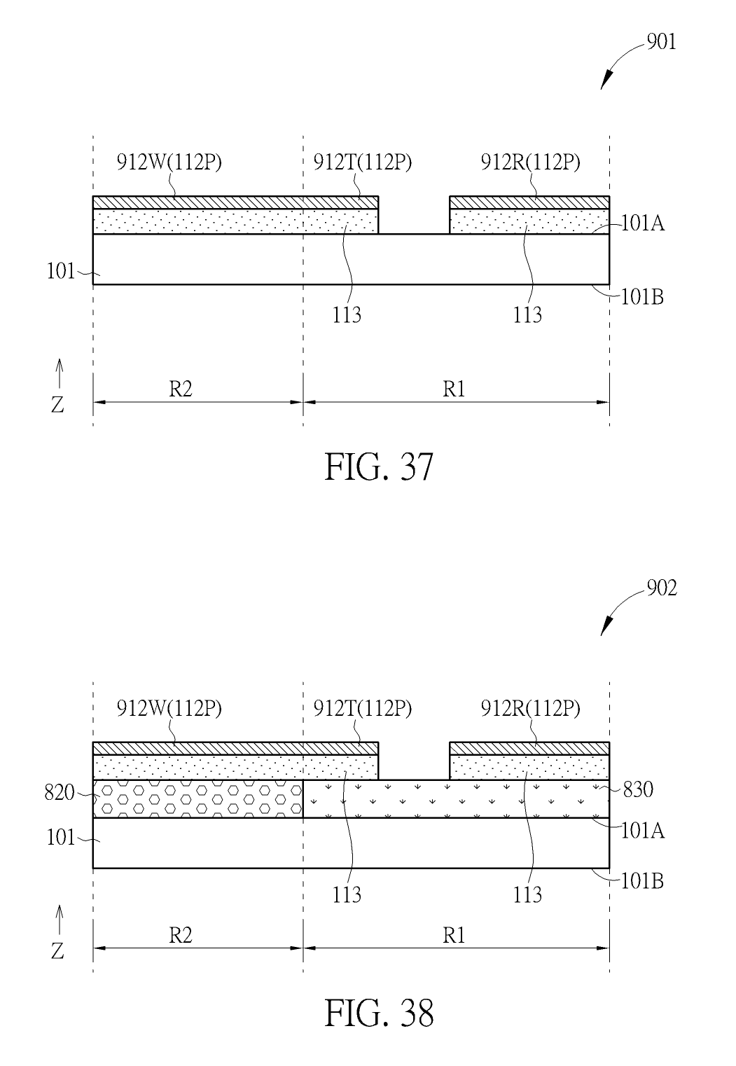

Please refer to FIGS. 36 and 37. FIG. 36 is a schematic diagram illustrating a touch panel according to a sixteenth embodiment of the present invention. FIG. 37 is a cross-sectional view diagram taken along a cross-sectional line H-H′ in FIG. 36. As shown in FIGS. 36 and 37, the embodiment provides a touch panel 901. The touch panel 901 includes the substrate 101, the first conductive pattern 112P and the first photoresist layer 113. The first conductive pattern 112P is disposed on the substrate 101. The first conductive pattern 112P includes a plurality of touch electrodes 912T and a plurality of touch electrodes 912R electrically isolated from each other. The first photoresist layer 113 is disposed between the first conductive pattern 112P and the substrate 101. The first photoresist layer 113 completely covers the first conductive pattern 112P along the direction Z perpendicular to the substrate 101. The first conductive pattern 112P completely covers the first photoresist layer 113 along the direction Z perpendicular to the substrate 101. The related manufacturing processes and material characteristics of the first conductive pattern 112P and the first photoresist layer 113 are illustrated in the aforementioned embodiments, and the identical features will not be redundantly described. It is worth noting that the touch electrodes 912T and the touch electrodes 912R in this embodiment are formed by simply employing the first conductive pattern 112P and the first photoresist layer 113, thereby simplifying the manufacturing processes and the structure. In this embodiment, the shape of the touch electrodes 912T is different from that of the touch electrodes 912R. Moreover, the touch electrodes 912T are preferably touch signal driving electrodes, and the touch electrodes 912R are preferably touch signal receiving electrodes so as to perform a mutual capacitance touch sensing together, but not limited thereto. In other embodiments of the present invention, the touch electrodes 912T and the touch electrodes 912R may have either similar or different shapes, such as a triangular, a rectangular, a rhombus or other suitable shapes, so as to perform the mutual capacitance touch sensing or the self capacitance touch sensing together. Additionally, the first conductive pattern 112P of the present invention may further include a plurality of trace lines 912W respectively electrically connected to the touch electrodes 912T and the touch electrodes 912R. Each of the trace lines 912W is electrically connected to one corresponding touch electrode 912T or one corresponding touch electrode 912R and formed as one piece. It is worth noting that, in the structure of this embodiment, the material of the first conductive pattern 112P is preferably nano silver yarn, but not limited thereto.

Please refer to FIG. 38. FIG. 38 is a schematic diagram illustrating a touch panel according to a seventeenth embodiment of the present invention. As shown in FIG. 38, the embodiment provides a touch panel 902. The difference between the touch panel of the aforementioned sixteenth embodiment and that of this embodiment is that the touch panel 902 further includes a decoration frame 820 and a filling layer 830 disposed on the substrate 101. The filling layer 830 is at least partially disposed in the transmissible region R1, and the decoration frame 820 is at least partially disposed in the peripheral region R2. The filling layer 830 is preferably formed after the decoration frame 820 is formed so as to fill the area of the substrate 101 without the decoration frame 820 so that negative effects, such as the severely uneven surface caused by the thickness of the decoration frame 820 in the subsequent processes, can be improved. The filling layer 830 preferably includes acrylic ester derivative or other suitable transparent filling materials, such as transparent resin. Moreover, the refractive index of the filling layer 830 is preferably the same as or similar to that of the first photoresist layer 113 so as to make the first conductive pattern 112P less distinct, but not limited thereto. Moreover, it is also possible that the decoration frame 820 is disposed but the filling layer 830 is not disposed in other embodiments of the present invention as taught in the above-mentioned fifteenth embodiment according to other considerations.

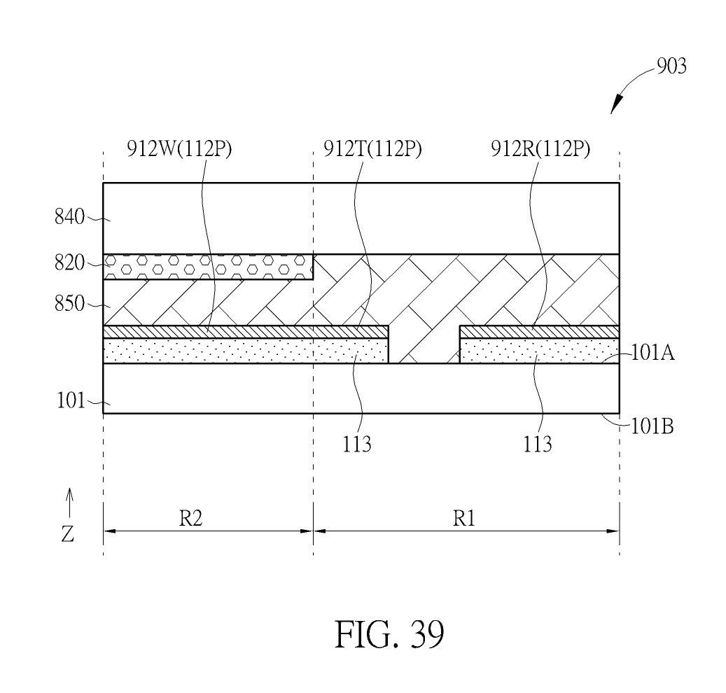

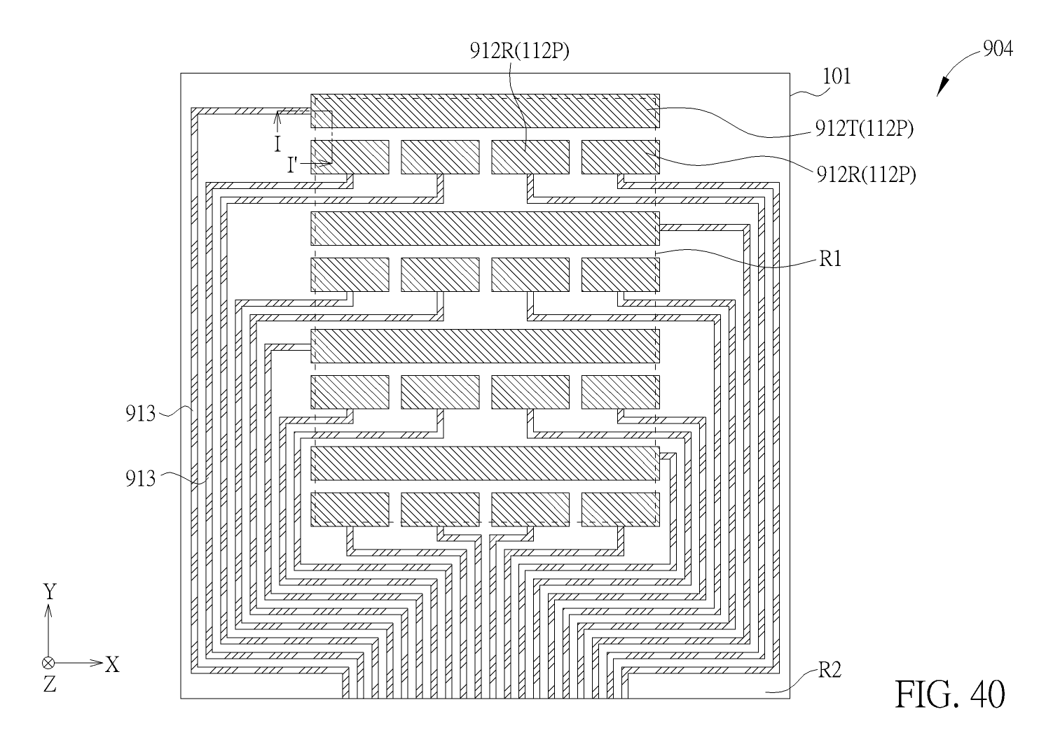

Please refer to FIG. 39. FIG. 39 is a schematic diagram illustrating a touch panel according to an eighteenth embodiment of the present invention. As shown in FIG. 39, the difference between the touch panel of the aforementioned sixteenth embodiment and that of this embodiment is that the touch panel 903 of this embodiment further includes a cover substrate 840 and an adhesion layer 850. The cover substrate 840 is disposed corresponding to the substrate 101. The adhesion layer 850 is disposed between the cover substrate 840 and the substrate 101 so as to adhere the cover substrate 840 and the substrate 101. The features of the cover substrate 840 and the adhesion layer 850 of this embodiment are illustrated in the above-mentioned embodiments, and the identical features will not be redundantly described.

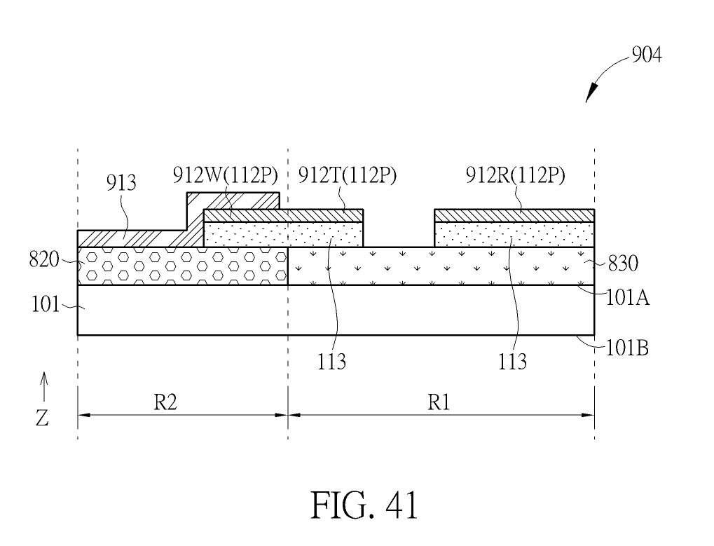

Please refer to FIGS. 40 and 41. FIG. 40 is a schematic diagram illustrating a touch panel according to a nineteenth embodiment of the present invention. FIG. 41 is a cross-sectional view diagram taken along a cross-sectional line I-I′ in FIG. 40. As shown in FIGS. 40 and 41, the embodiment provides a touch panel 904. The difference between the touch panel of the aforementioned sixteenth embodiment and that of this embodiment is that the touch panel 904 includes a plurality of trace lines 913 respectively electrically connected to the touch electrodes 912T and the touch electrodes 912R. Each of the trace lines 913 is at least partially disposed on one touch electrode 912T or one touch electrode 912R so as to be electrically connected to the touch electrode 912T or the touch electrode 912R. The trace lines 913 preferably include metal conductive materials, such as silver paste or other metal conductive materials with resistivity lower than that of the first conductive pattern 112P in order to improve the signal transmission performance of the wires on the periphery of the touch panel 904, but not limited thereto.

To sum up, in the touch panel of the present invention, after exposure processes and development processes are carried out, conductive patterns are directly formed on the substrate and simply formed from the photosensitive conductive film. The photosensitive conductive film is made of the release film, the conductive layer and the photoresist layer stacked to one another, and the fabrication process is simplified. Moreover, the size is miniaturized and the overall yield rises. In addition, since the photosensitive conductive film includes the conductive layer, the conventional film deposition process at high temperature will not be necessary to form the transparent conductive layer. Therefore, a low temperature process is realized in the method for fabricating the touch panel in the present invention. In other words, the choice range of the substrate becomes wider and the fabrication methods are further simplified. On the other hand, the wires in the present invention are formed from materials of high conductivity in order to improve the signal transmission performance of the wires on the periphery of the touch panel. Besides, with the filling layer of the present invention, negative effects, such as the severely uneven surface caused by the decoration frame disposed, can be improved so as to enhance the yield rate and product quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate, having an upper surface;
a first conductive pattern, disposed on the substrate, and comprising a plurality of first axis electrodes;
a first photoresist layer, disposed between the substrate and the first conductive pattern, wherein the first photoresist layer completely covers the first conductive pattern along a direction perpendicular to the substrate;
a second conductive pattern, disposed on the substrate, wherein the second conductive pattern comprises a plurality of second axis electrodes, and the second axis electrodes are electrically isolated from the first axis electrodes; and
a second photoresist layer, disposed between the substrate and the second conductive pattern, wherein the second photoresist layer completely covers the second conductive pattern along the direction perpendicular to the substrate, and the first conductive pattern, the first photoresist layer, the second conductive pattern, and the second photoresist layer are disposed on the upper surface of the substrate.

2. The touch panel of claim 1, wherein the first conductive pattern completely covers the first photoresist layer along the direction perpendicular to the substrate.

3. The touch panel of claim 1, wherein the second conductive pattern completely covers the second photoresist layer along the direction perpendicular to the substrate.

4. The touch panel of claim 1, wherein the first conductive pattern is at least partially disposed between the second photoresist layer and the substrate.

5. The touch panel of claim 4, wherein a thickness of the first photoresist layer not covered by the first conductive pattern is equal to or thinner than a thickness of the first photoresist layer covered by the first conductive pattern.

6. The touch panel of claim 1, further comprising a covering layer, disposed on the substrate to cover the first conductive pattern, wherein a refractive index of the covered layer is smaller than a refractive index of the first conductive pattern.

7. A touch panel, comprising:
a substrate, having an upper surface and a lower surface opposite to the upper surface;
a first conductive pattern, disposed on the upper surface of the substrate, and comprising a plurality of first axis electrodes;
a first photoresist layer, disposed between the substrate and the first conductive pattern, wherein the first photoresist layer completely covers the first conductive pattern along a direction perpendicular to the substrate;
a second conductive pattern, disposed on the lower surface of the substrate, and comprising a plurality of second axis electrodes, and the second axis electrodes are electrically isolated from the first axis electrodes; and
a second photoresist layer, disposed between the substrate and the second conductive pattern, wherein the second photoresist layer completely covers the second conductive pattern along the direction perpendicular to the substrate.

8. The touch panel of claim 7, wherein the first conductive pattern completely covers the first photoresist layer along the direction perpendicular to the substrate.

9. The touch panel of claim 7, wherein the second conductive pattern completely covers the second photoresist layer along the direction perpendicular to the substrate.

10. The touch panel of claim 7, wherein a thickness of the first photoresist layer not covered by the first conductive pattern is equal to or thinner than a thickness of the first photoresist layer covered by the first conductive pattern.

11. The touch panel of claim 7, wherein a thickness of the second photoresist layer not covered by the second conductive pattern is equal to or thinner than a thickness of the second photoresist layer covered by the second conductive pattern.

12. The touch panel of claim 7, wherein the second conductive pattern further comprises a plurality of dummy electrodes, and each of the dummy electrodes is disposed between two of the second axis electrodes.

13. A touch panel, which comprises:
a substrate, having an upper surface;
a first conductive pattern, disposed on the substrate, and comprising a plurality of bridge conductors;
a first photoresist layer, disposed between the substrate and the first conductive pattern, wherein the first photoresist layer completely covers the first conductive pattern along a direction perpendicular to the substrate;
a second conductive pattern, disposed on the substrate, and comprising a plurality of second axis electrodes and a plurality of first electrodes, the bridge conductors are electrically isolated from the second axis electrodes, and each of the bridge conductors is electrically connected to at least one of the first electrodes; and
a second photoresist layer, disposed between the substrate and the second conductive pattern, wherein the second photoresist layer completely covers the second conductive pattern along the direction perpendicular to the substrate, and the first conductive pattern, the first photoresist layer, the second conductive pattern, and the second photoresist layer are disposed on the upper surface of the substrate.

14. The touch panel of claim 13, further comprising at least one connecting line, disposed on the substrate, wherein each of the bridge conductors is electrically connected to the first electrode through the connection line.

15. The touch panel of claim 13, wherein the first conductive pattern is at least partially disposed between the second photoresist layer and the substrate.
